(19) United States
(12) Patent Application Publication
(10) Pub. No.: US 2004/0039924 A1
(43) Pub. Date: Feb. 26, 2004

(54) System and method for security of computing devices

(76) Inventors: Robert W. Baldwin, Palo Alto, CA (US); Jean-Paul Abgrall, San Jose, CA (US); John D. Barr, San Jose, CA (US); Jose A. Casillas, San Jose, CA (US); David P. Jablon, Westboro, MA (US); Timothy J. Markey, San Jose, CA (US); Pannaga Kotla, Sunnyvale, CA (US); David Pitard, (US); Kai Wang, Santa Clara, CA (US); Stephen D. Williams, Santa Cruz, CA (US)

Correspondence Address: IRELL & MANELLA LLP, 840 NEWPORT CENTER DRIVE, SUITE 400, NEWPORT BEACH, CA, 92660, US

(21) Appl. No.: 10/342,709

(22) Filed: Jan. 14, 2003

Related U.S. Application Data
(63) Continuation-in-part of application No. 09/829,074, filed on Apr. 9, 2001.

(51) Int. Cl. G06F 12/14

(52) U.S. Cl. 713/189

(57) ABSTRACT

System and method for securing a computing device using a master cryptographic key that is bound to the device. The master key is used to derive sensitive data that is transferred to storage that is only accessible in a restricted mode of operation. The master key is used to derive one or more application keys that are used to secure data that is specific to an application/device pair. Non-privileged programs can request functions that run in a more restricted mode to use these application keys. The restricted mode program checks the integrity of the non-privileged calling program to insure that it has the authority and/or integrity to perform each requested operation. One or more device authority servers may be used to issue and manage both master and application keys.

### CROSS-REFERENCE TO RELATED APPLICATION

The present application is a continuation-in-part application of U.S. patent application Ser. No. 09/829,074, entitled “System and Method for Security of Computing Devices,” filed Apr. 9, 2001.

### BACKGROUND

The present invention relates generally to computer systems and software methods, and more particularly, to systems and methods that provide for computer device security, integrity, and authentication.

Personal computing devices are becoming an increasingly important part of our world, and as these devices are interconnected with the Internet, it becomes increasingly important to securely authenticate the entities involved in transactions using these devices.

The concept of a secure kernel that performs privileged operations within a protected sub-domain of an operating system is a very old concept in computer security. However, during the evolution of modern commercial operating systems, as is reflected in various versions of Microsoft Windows, UNIX, and in embedded operating systems of small devices, the traditional security boundaries and responsibilities of the operating system have become blurred, displaced, and/or riddled with security holes. In some cases, the operating system has grown so large as to render it almost impossible to be able to guarantee the assurance of or even analyze the system in any comprehensive manner. While such an assurance process might be possible in principle, it appears to be impractical to achieve within the expected lifetime of these systems.

Some systems have incorporated physically or architecturally separate peripherals and devices, each containing distinct CPUs, to contain security-critical data and perform security-critical functions within a larger system. One example is a smart card based authentication device. The smart card device provides a separate operating environment that has sole access to one or more embedded cryptographic keys. It can be attached to a traditional computer to perform digital signatures with the embedded key, to authenticate users and transactions initiated by the computer. It is also small and simple enough to have its security properties analyzed in a relatively comprehensive process. However, smart cards and other add-on devices have a signifiant limitation: They introduce added cost and complexity to the environment, often requiring card readers to be installed by users and systems administrators, and requiring smart cards to be distributed to users of these machines.

Another example of a hardware-based solution is the use of a secondary crypto-processor in the system that has local private storage for keys. This functions in a manner similar to an always-inserted smart card.

In the field of user authentication, a wide variety of mechanisms have been used, based on stored and/or memorized keys, passwords (including PIN codes and passphrases, Passfaces, etc) and biometrics. Different categories of factors, such as something you have, something you know, and something you are, each have different strengths and weaknesses. A respectable practice is to combine such techniques using so-called multi-factor user authentication, where multiple techniques in different classes are used together to strenthen the act of authenticating a user.

Another limitation of many of these hardware-add-on systems, beyond the added cost and complexity, is that the add-on device, which may contain a CPU, does not have its own user input and output devices. A smartcard may rely on other components to perform user input and output functions. Specialized hardware to provide trustworthy user I/O systems may add further cost and complexity to these devices, and are often extremely limited in functionality and convenience. A cryptographic add-on device with an embedded CPU that relies completely on the attached computer to tell it what to sign and process with the embedded keys is vulnerable to any security threats on the attached computer, which removes some of the containment value of the device. Due to the isolation of these separate devices, it is generally difficult or impossible for the device to ensure that the transaction being presented to it by the host machine is genuine. Thus, in some respects, these systems are still ultimately dependent on the integrity of the host operating system and applications.

### OBJECTIVES OF PRESENT INVENTION

It is an objective of the present invention to provide a strong cryptographic key containment and management system for the purposes of enabling device authentication and other security applications.

It is another objective of the present invention to provide high assurance with a minimum of added hardware to the computer.

It is another objective of the present invention to provide a system that permits for computer device authentication that requires exactly no more hardware than is found in a commodity-class commercial personal computer.

It is another objective of the present invention to provide a small security kernel that operates in a separate domain from both the application and the operating system, to facilitate the process of analyzing and establishing trust in the implementation of the security kernel.

It is another objective of the present invention to permit the security kernel to access the memory of the operating system (OS) and application programs (Applications), in part, in order to establish the authenticity and integrity of these programs, and in particular those programs that request security kernel functions.

### SUMMARY OF THE INVENTION

To accomplish the above and other objectives, the present invention comprises systems and methods that provide for computer device authentication and authentication of application and operating system software.

The present invention provides a small security kernel, that facilitates the process of analyzing and establishing trust in the implementation of the kernel, while at the same time removing the limitations of the aforementioned add-on hardware solutions. Ideally, the security kernel operates in a separate domain from both the application programs (applications) and the operating system (OS) running on the host machine, and yet with access to the memory of the OS and applications. The present invention provides such a security architecture by creating a small inner security kernel within the boundaries of a traditional existing operating system, and that can verify the integrity of and perform secure operations on behalf of the OS and applications.

Another important aspect of this invention is that it enables the security kernel to be tied into an infrastructure that can establish trust via between two devices (e.g., client device and DSS), in some embodiments via a shared symmetric key.

Key aspects of the present invention comprise

(1) Open-at-reset lockable (OAR-locked) non-volatile memory (NVM) that contains a secret master key, called the Device Master Key or DMK, which is unique to the device. The DMK is moved into SMRAM, a specially controlled region of memory that is only accessible in a System Management Mode (SMM) at startup, and whereafter OAR-locked non-volatile memory is disabled,

(2) containers to bind the DMK to specific applications, and that solves privacy/user controllability problems, and

(3) spot checking of the integrity of a calling application “on-the-fly”.

The invention also provides Application Keys that are bound to the device and to Applications, and, optionally, to Customer-Secrets provided by the Applications. A given application can have several different keys corresponding to different values of the Customer-Secret.

These keys that are bound to the device are used to perform device authentication for the purposes of supplementing user authentication, for protecting content to be distributed only to the specific device, and for implementing or enhancing a virtual smart card. These applications may use locally stored and/or remotely retrieved credentials, in the form of public/private keys or shared credentials, such as keys and passwords. The key container is used to enhance protection for system-critical keys, such as in a replacement for the default Crypto API container.

The Device Master Key is used indirectly to authentication both the device and the application running on that device. An important aspect of this invention is that the device does not necessarily have a single identity, but instead has different keys for different applications. This has many privacy related benefits.

(1) One exemplary system for using and protecting access to a device master cryptographic key comprises

(a) non-volatile storage,

(b) a system initialization process that reads the master key from the non-volatile storage during a system initialization process, writes a sensitive value derived from the master key to a hidden storage location, and disables access to the non-volatile storage by any program running in the system until the next start of system initialization process,

(c) means to prevent access to the hidden storage location by programs running in the normal operating mode of the system, and

(d) means to allow access to the hidden storage location by a program running in a restricted operating mode of the system.

(2) Another exemplary system for hiding a master cryptographic key in storage comprises power-on software that reads a master key from non-volatile storage, closes access to the non-volatile storage such that access does not become available again until the next system reset, and writes sensitive data derived from the master key to a hidden address space, and wherein only a program that runs in a restricted operational mode of the system has access to the sensitive data in the hidden address space.

(3) An exemplary method is provided for controlling read and write access to application data by restricting the availability of a cryptographic key to an application comprised of specific software code. The method comprises (a) a master key, (b) an application container data structure (AppContainer) that holds a sealed or unsealed form of the data that the application wants to access, (c) a cryptographic gatekeeper module (CryptoGate) that performs a cryptographic digest of a portion of the code bytes that make up the calling application, called the Application Code Digest (AppCodeDigest), and (d) a cryptographic module (CryptoEngine) that includes an integrity checking function that examines the AppContainer and AppCodeDigest, and the master key to (i) determine if the application is allowed to unseal the data in the given AppContainer, or (ii), when sealing the data, modifies it to add the integrity check information to the AppContainer. A benefit of this approach is that it enables creating systems where the application must contact a central server to get its first AppContainer.

(4) The present invention also provides for a method of controlling access to data to an application by restricting the availability of a cryptographic key to a specific application on a specific device. The method comprises (a) a master key known to a CryptoEngine, (b) an AppContainer application that contains a cryptographically sealed form of the data that the application wants to access, (c) a CryptoGate function that intercepts all access between application-level programs and the CryptoEngine, includes (d) a means to examine a portion of the bytes of an executable in-memory image of an application program that is attempting to access cryptographic services or data and compute a cryptographic digest of the portion of the bytes to compute the AppCodeDigest of the application, and (e) an integrity check method performed by the CryptoEngine that (i) examines the AppContainer and AppCodeDigest and the master key to determine if the application is allowed to unseal the data in the given AppContainer, or (ii) when sealing the data, modifies it to add the integrity check information.

(5) The present invention also provides for a method for authenticating an identified application on an identified device to another computing component, such as an authentication server or an application registration server, with the help of another computing component called a Device Authority. The method comprises an enrollment method, a registration method and an authentication method. These servers may perform the functions of authentication of the device and/or enforcement and management of software licenses for software applications on the device.

The Device Master Key may be known to, and in fact generated in cooperation with, another server that can compute application keys and share them with other entities to establish trust and authentication of devices and device-bound applications.

(6) The enrollment method includes the steps of (a) a first sequence of cryptographic operations performed during a privileged processing mode, on the device producing a result that is sent to the Device Authority, and (b) a second cryptographic operation performed during the privileged processing mode on the device processing a value generated by the Device Authority that is received by the device. An example of a privileged processing mode is the System Management Mode (SMM) of operation of an Intel x86-compatible processor, which is invoked when processing a System Management Interrupt (SMI), using an SMI interrupt service function.

The invention may be embodied in several ways, using combinations of symmetric and asymmetric cryptography, such as (1) where the device has an asymmetric (public) key for the Device Authority, or (2) where the device has a symmetric key for the Device Authority, or (3) where the device has its own pair of asymmetric keys, and perhaps certificate, or combinations of the above.

(7) The registration method includes the steps of (a) a first cryptographic operation performed during the privileged processing mode on the device producing a result that is sent to the authentication server, (b) a second cryptographic operation performed by the authentication server producing a cryptographic variable that is stored for use during the authentication method, and (c) an optional third cryptographic operation performed during the privileged processing mode on the device processing a value generated by the authentication server that is received by the device.

(8) The device authentication method that includes the steps of (a) a first cryptographic operation performed during a privileged processing mode on the device producing authentication data that is sent to the authentication server, and (b) a second cryptographic operation performed by the authentication server on the authentication data received from the device using at least the cryptographic variable stored during the registration method to determine the result of the authentication.

These cryptographic operations can use event or counter based authentication, record authentication, and challenge/response authentication.

(9) The present invention also provides for a method for authenticating an identified application on an identified device, or for providing a second factor for identifying a user of the identified device to another computing machine comprising an authentication server. The method comprises an enrollment application that (a) performs an enrollment method involving communication with a Device Authority and an authentication server to create an AppContainer on the device, wherein the AppContainer is a data structure that is cryptographically associated with the application, and (b) stores credential information, wherein the authentication server stores an application key for the AppContainer. AppKeys and CustAppKeys are two types of application keys that are described below. An application runs on the identified device that performs an authentication method including the steps of (a) unsealing the AppContainer that stores the credentials, (b) modifying the credentials, (c) resealing the AppContainer, (d) sending identifying information and at least a portion of the resealed AppContainer to the authentication server, and wherein at least part of the resealing operation takes place during an SMI on the same CPU that executes the code of the application. The authentication server (a) receives the identifying information and at least a portion of the AppContainer, (b) uses the identifying information to lookup or compute an application key to unseal the container, (c) if the unsealed AppContainer has acceptable values then the specific application on a specific device is considered to be authenticated, and (d) stores an application key that is associated with the AppContainer.

The invention does not necessarily or typically require communication with a Device Authority for each authentication.

(10) The present invention provides for a method for creating and utilizing one or more virtual tokens on a device for purposes such as authentication, privacy, integrity, authorization, auditing, or digital rights management. The method comprises an application that processes specific types of virtual tokens, an AppContainer for each type of virtual token, a CryptoGate component that computes an AppCodeDigest of a calling application that is requesting cryptographic services of a CryptoEngine component.

The CryptoEngine is accessed via the CryptoGate component, knows one or more long-lived symmetric keys and one or more long-lived public keys, and performs cryptographic sealing and unsealing of AppContainers, where a portion of the cryptographic operations are performed during a privileged processing mode, such as the context of an SMI interrupt.

The CryptoGate component itself may or may not know one or more long-lived symmetric keys. The CryptoGate component checks the integrity of the calling application by checking a digital signature (typically a digitally signed cryptographic digest or hash) of a portion of the application's code or static data, using a public key that has been loaded into the CryptoEngine and an AppCodeDigest reference value. The AppCodeDigest value includes a recently computed cryptographic hash of a portion of the calling application's in-memory image.

The CryptoGate and CryptoEngine (a) derive a key for unsealing the application container from the master key and AppCodeDigest and other optional information, (b) use the derived key to check the message authentication code on the AppContainer, and (c) if the message authentication code is correct, use the derived key to decrypt the AppContainer data and return it to the application.

The CryptoGate in this invention knows the value of MKKeys to unseal MKContainers. Only the CryptoEngine knows the value of AppKeys to unseal AppContainers. The derived key for the message authentication code can be different from the derived key to decrypt the AppContainer data, and is in fact different in the preferred embodiment.

(11) The present invention also provides for a method of securely associating a private key with an application and with a device that comprises creating an AppContainer that contains private keys secured by a key associated with the device.

### BRIEF DESCRIPTION OF THE DRAWINGS

The various features and advantages of the present invention may be more readily un-derstood with reference to the following detailed description taken in conjunction with the accompanying drawings, wherein like reference numerals designate like structural elements, and in which:

FIG. 1 is a simplified block diagram illustrating components of an exemplary computer device authentication system in accordance with the principles of the present invention;

FIG. 2 illustrates a client component hierarchy;

FIG. 3 illustrates OS Driver (OSD) component interaction;

FIG. 4 is a block diagram illustrating multi-factor client authentication (MFCA) registration;

FIG. 5 is a flow diagram that illustrates a first exemplary method to unseal data for an application in accordance with the principles of the present invention;

FIG. 6 is a flow diagram that illustrates a second exemplary method to seal data for an application in accordance with the principles of the present invention;

FIG. 7 is a flow diagram that illustrates a third exemplary method in accordance with the principles of the present invention;

FIG. 8 is a flow diagram that illustrates a fourth exemplary method in accordance with the principles of the present invention; and

FIG. 9 is a flow diagram that illustrates a fifth exemplary method in accordance with the principles of the present invention.

### DETAILED DESCRIPTION

1. Definitions

In order to better understand the present invention, a number of definitions that are used in the present description are presented below.

A device is a computing device such as a desktop, laptop, handheld or wireless machine that includes a firmware layer that controls the bootstrap operations of the machine at time of start-up, such as when power is first turned on. The firmware software environment may execute before the operating system and applications are run, and may be accessible intermittently while the operating system and applications are running. Examples of such firmware include the boot ROM and BIOS firmware of a standard personal computer, or an equivalent hardware abstraction layer (HAL).

A Device Authority comprises software resident on one or more server computing machines that help to enable the security features of a device. A Device Authority operates in a secure environment with procedures that allow other organizations to trust its behavior.

A Device Master Key (DMK) is a secret cryptographic variable known only to the device and, in some embodiments, to one or more Device Authority machines. It can be used directly as a cryptographic key for encryption or integrity checking or as an input to a function that derives other cryptographic variables or keys.

An Application Code Digest (AppCodeDigest) is a one-way cryptographic transformation of a portion of the bytes of an executable in-memory image of a program and/or its static data. The transformation may be performed by functions such as SHA1, MD5, RIPEMD160, SHA-256, SHA-512, or CBC-MAC.

An Application Key (AppKey) is a cryptographic variable that can be used directly as a cryptographic key for encryption or integrity checking or as an input to a function that computes other cryptographic variables or keys. Its value is specific to a device and application pair, and is derived from an Application Key Part and an optional Customer Secret (CustSecret). The Application Key Part (AppKeyPart) is a value provided by the application and is derived from a hash of the DMK and the AppCodeDigest.

A Customer Secret (CustSecret) is a cryptographic variable chosen by some component of an application system which may or may not be running on the device. It is associated with an authentication server in a specific enterprise, and may be associated with many devices authorized for that application in that enterprise domain.

A Customer Application Key (CustAppKey) is a cryptographic variable derived from a CustSecret, an AppCodeDigest and a DMK, and can be used directly as a cryptographic key for encryption or integrity checking or as an input to a function that computes other cryptographic variables or keys.

An Application Container (AppContainer) is a data structure that can be cryptographically sealed or unsealed using a CustAppKey or an AppKey, where the sealing operation provides privacy and integrity checking and optionally authenticity for the identity of the application that seal sealed the container.

The cryptographic engine (CryptoEngine) performs cryptographic operations in a restricted mode that is only accessible during normal operation by transferring control from a normal mode of the processor to a restricted mode of the processor via CryptoGate. The restricted mode operations may also include operations where sensitive data is available to the processor during secure bootstrap and Power-On Self-Test operations. The CryptoEngine is capable of storing and recalling high integrity public keys, and of storing at least one long-lived symmetric key (the DMK), and of deriving symmetric keys from the long-lived symmetric key(s), and of performing symmetric cryptography (both integrity and privacy primitives) and public key cryptography, and of pseudo random number generation, and optionally of private key cryptography, and optionally of other cryptographic support functions such a key generation and importing and exporting keys. Some embodiments of the CryptoEngine may use specialized cryptographic hardware, such as smartcards, or a TCPA TPM.

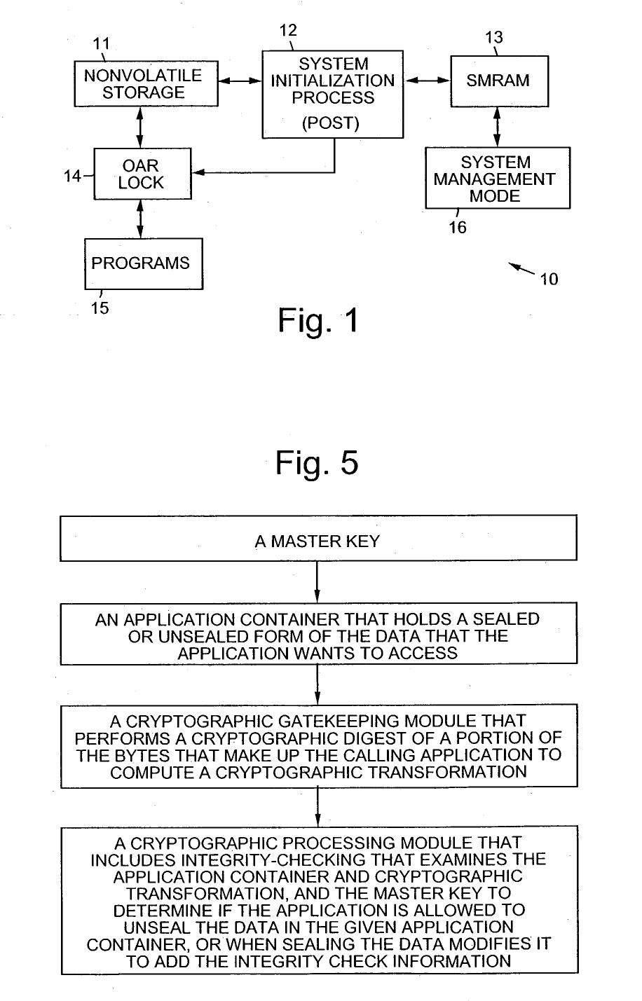

Referring to an exemplary embodiment shown in FIG. 1, a cryptographic gatekeeper module (CryptoGate) 17 intercepts all access between application-level programs and the CryptoEngine 18, and is capable of examining a portion of the bytes of an executable in-memory image of a program and/or its static data for the program that is attempting to access cryptographic services or data. CryptoGate can make access control decisions and provide additional parameters (like the AppCodeDigest) to the CryptoEngine.

An Authorization Buffer (AuthBuffer) is a data structure that allows a specific application to perform a set of operations provided by the CryptoGate and/or CryptoEngine, where the data structure includes the AppCodeDigest and a description of the portion of the application's code and static data that make up the portion included in the code digest, and it includes a digital signature that can be verified by the CryptoEngine. An AuthBuffer may also include information about allowed sets of operations, and allowed parameters for those operations. For example, an AuthBuffer can allow an Application to unseal AppContainers created by any one of a list of AppCodeDigest values.

A Message Authentication Code (MAC) is a value that is used to check the integrity of a message or data structure that is computed on a portion of the bytes of the message in a manner that requires a cryptographic variable that is not widely known. Well known algorithms for this include CBC-MAC, DMAC, and HMAC (based on well known hash functions such as MD5 and SHA1).

A System Management Interrupt (SMI) is an interrupt feature included with the System Management Mode that is supported by many CPUs. An SMI allows BIOS-level software to gain exclusive access to the CPU and to SMRAM, a persistent memory address space that is not easily available outside of SMM.

2. Design Architecture

A high level design of the present invention will first be described. In general, the architecture of the preferred embodiment of the computer device authentication system comprises one or more device authorities, a Client Cryptographic Engine (CryptoEngine), in one embodiment using firmware, locked nonvolatile memory and privileged processing mode (such as SMM), an operating system driver (OSD), a cryptographic gatekeeper module (CryptoGate) that performs a cryptographic digest of a portion of the code bytes that make up the calling application, enabled client applications (Apps), an authentication server (PASS server), and enabled server applications.

An online enrollment process is provided between a client device and an enrollment server. Transaction level application program interfaces (APIs) provide client server applications with extended device authentication functions. The system supports security functions for both on-line client/server applications and off-line standalone functions. Eenrollment can happen via hardcopy mail or electronic mail or even during manufacturing (e.g., for music players).

The authentication server is a component of any cryptographically-enabled server application. Its primary purpose is to perform cryptographic functions related to secure device-enabled applications. To perform these functions, the authentication server seals and unseals containers that are exchanged with a cryptographically-enabled client device, using the assistance of one or more Device Authority servers as needed. The authentication server maintains a table of Key ID (KID) values.

The Device Authority server primarily deals with registration of device identifiers and keys. In some embodiments the Device Master Key (DMK) is a shared secret between the device and one or more device authorities. In this case, the Device Authority must perform all cryptographic operations that need access to the Device Master Key on behalf of authentication servers and other application servers. The DMK may also be used to protect access to one or more stored private keys for use in a public key encryption or digital signature system. In this case, a Device Authority may not be needed to assist authentication and application servers, when they can use the devices public keys and any related certificates for such functions. Alternately, the DMK may itself be a private key.

Device Identifiers are not necessarily defined by the system. Device identification is a function that may be left to specific applications, with many possible embodiments. A primary embodiment is to identify the device using a cryptographic one-way digest of the DMK.

The present invention provides support for AppContainers. The Device Authority delivers an AppKeyPart to the authentication server. The server implements an algorithm that allows creation of AppContainers. This algorithm requires access to the DMK and the AppCodeDigest (ACD) and thus may be invoked only on machines where the DMK is stored, such as the owning device or an appropriate Device Authority server. The Device Authority defines how to associate an application with the client PC and how, to register it using the operating system driver. This is done online using any appropriate communication method from any server as long as the first AppContainer is created by a Device Authority server.

The Device Authority must deliver an Encrypted Owners Code Digest along with the AppKeyPart. This can be done by delivering an AppContainer along with the AppKeyPart.

Utilities create AppCodeDigests for applications. These utilities may run under the same operating system as the applications are expected to run.

Furthermore, there are several embodiments of the Client Cryptographic Engine (CryptoEngine) employed in the present invention, which take advantage of various hardware features that are available, or may soon be available, on all general-purpose personal computers. Embodiments may also take advantage of specialized security components such as smart cards and TCPA TPM hardware, whether or not they are included in standard general-purpose systems.

A Master Key Container data structure (MKContainer) is used to send encrypted messages between different machines, The contents of the MKContainer is symmetrically encrypted with a session key.

A Public Key Container (PubKContainer) is used to send encrypted messages between a client and a server with the message data encrypted using the server's public key.

A Signed Containers (SignedContainers) is encrypted with a party's private key.

MKContainers in combination with PubKContainers provide many of the benefits of SSL/TLS secured connections or S/MIME or PGP secure E-Mail. A variety of methods may be used to derive the symmetric session key that seals and unseals MKContainers.

Notice that “master key” in this context is very different from the DMK for the Device.

An Authorization Buffer (AuthBuf) is a special type of SignedContainer that is used to verify that an application has the authority to access the CryptoEngine.

3. Preferred Embodiment

FIG. 1 is a simplified block diagram illustrating components of an exemplary computer device identification system in accordance with the principles of the present invention. A preferred embodiment of the present invention comprises a non-volatile memory (NVM) 11 that is protected by an open-at-reset latch-protection mechanism (OAR-lock) 14, a BIOS ROM system initialization module 12, and a System Management Mode (SMM) 16, accessed from the normal mode of operation of the system via a System Management Interrupt (SMI).

The protected non-volatile memory 11 is used to store the secret device master key. The BIOS system initialization module 12 is responsible for securely transferring the secret DMK from non-volatile memory 11 into SMRAM 13, a protected memory region that is only addressable from SMM 16. After the DMK is transferred into SMRAM 13, the system initialization module 12 closes the OAR-lock latch 14 to render the non-volatile memory 11 inaccessible to programs 15 running in the system until the next system reset. The DMK is only available in hidden SMRAM 16 during normal operation of the system.

The OAR-lock protection mechanism 14 prevents the non-volatile memory 11 from being read by any program 14 other than the ROM system initialization module 12 that runs at time of startup. After reading the non-volatile memory 11, the system initialization module 12 closes the latch 14 to render the non-volatile memory 11 totally inaccessible until the next system reset, at which time the system initialization module 12 regains control.

4. A Second Embodiment

An alternative to using OAR-locked non-volatile memory 11 when its not available is to store a share of the DMK in the BIOS ROM boot block, typically a 16K byte region of ROM that is mapped to be non-addressable by the system after power-on/self-test operations at system startup in the BIOS system initialization module 12. There are also other locations that are rendered not generally accessible to applications after system startup with varying levels of assurance.

SMM is a special restricted mode of operation in Intel x86-compatible processors which has additional unique features which illustrate the advantages of a protected execution mode. An ordinary software debugger can not single step through SMM code, nor can the System Management memory (SMRAM) be conveniently viewed except when in SMM. This mode is used to hide the DMK on a client PC during normal operation of the machine, and use the DMK for a variety of security purposes that need to be bound to the authentic identity of the machine.

Note that an attacker with physical access to the device, using hardware tools such as a logic analyzer, may be able to discern the contents of SMRAM. However, a high level of protection against internal software-based attack is a primary goal of the invention, and a worthwhile goal, whether or not measures are also taken to defend against physical attack.

Note that it may also be possible, depending on the implementation, to exploit flaws in hardware design and read the contents of SMRAM using specialized non-SMM software. Yet, the invention still has value in such implementations when it significantly increases the attacker's work factor.

None of the afore-mentioned special features (BIOS ROM code, OAR-locked non-volatile memory 11, and System Management Mode 16) are absolutely required for the operation of the system, but together they provide the system with a higher level of assurance of secure operation.

5. A Third Embodiment

In an alternative software-only CryptoEngine embodiment, the same functionality is provided, with a lower level of assurance of temper prevention. The restricted mode of operation in this case is the standard “ring zero” operating system protection, where the CryptoEngine functions are implemented inside of a system device driver called the operating system driver. Because the operating system driver is not running in SMM, it is not as secure as the BIOS-enhanced product. Therefore special additional modifications and obfuscation techniques are also included in the software-only form of the embodiment to protect the DMK from being found and copied. In addition, because the DMK is stored on the file system and not on the motherboard, additional device detection is added into the operating system driver to bind the DMK to the personal computer.

Furthermore, in embodiments where the software-only system does not run in a restricted mode, the code includes special features intended to make it more difficult to reverse-engineer and “hack”.

In various software-only forms of the CryptoEngine, a variety of techniques are used to provide the strongest possible protection for the DMK and core cryptographic operations.

The present invention binds a device to a secret master key, called the Device Master Key (DMK). There is an association between the DMK and the machine so that a DMK cannot be transferred by unauthorized means from one machine to another. In a software-only embodiment of the system that does not run in a restricted mode, this association between device and DMK is based on a threshhold secret splitting scheme that uses multiple machine identifying metrics. This scheme allows for the user to incrementally upgrade their machine by making a series of hardware changes that create relatively small changes in the set of metrics, so that the system doesn't lose the ability to use the DMK. When the DMK is bound tightly to a specific disk drive in the system, reformatting the hard drive or exchanging it with another system will disable the use of the DMK.

The present invention provides for limited DMK and session key exposure. The design limits the exposure of the DMK and the session keys when using them for any operation.

The present invention provides for hack resistance. Due to the fact that a software-only CryptoEngine may not have the ability to (1) hide the DMK in a privileged location (such as SMRAM) or (2) disable viewing of code operation in the restricted mode (e.g. SMM) as the firmware (e.g. BIOS) can, the software-only CryptoEngine code employs additional methods to deter hacking. In addition, the software CryptoEngine employs techniques for storing the DMK that prevent a universal program from determining the DMK.

6. Overview of Device Authority

Device Authority components perform the following functions: The Device Authority enrolls a device, stores a copy of its DMK, and registers applications for devices by providing an AppKey specific to an application and device pair. The Device Authority and accompanying modules are explained briefly here and in more detail later on. One device authority can provide services to other device authorities, such as creating AppContainers and AppKeyParts.

The client application is a cryptographically-enabled application, typically running on a Microsoft Windows-based personal computer (PC). The client application allows a user to test whether the device has been enrolled, enroll the device and display a Key ID (if needed), register an application on the device, verify the integrity of portions of application, manipulate AppContainers—including Create, Edit, Delete, post AppContainers to the authentication server, get AppContainers from the authentication server, and un-enroll the device.

The authentication server is a component of the server portion of a client/server cryptographically-enabled application. It is responsible for authenticating things that come from the client. The authentication server is a software component that receives a request for registration from a client device, requests an AppKey from the application registration module and store it, creates an AppContainer and send to Client device, provides a user interface (UI) to manipulate AppContainers (Create, Edit, Seal and Unseal) through a UI, and receives AppContainers from the Client device.

The authentication server can also create commands inside of AppContainers for the applications running on the Device, and those applications can be sure that the commands are authentic. Two applications running on the same device can send each other private, authenticated, tamper-detecting messages using AppContainers. For example, a program that accepts secure keyboard input (e.g., passwords) can send the input to a specific application without other applications being able to read the input.

The Device Authority is made up of several components and has at least the following functionality. An enrollment module receives requests to enroll a device. It passes up the client half of the DMK and generates the other half returning it to the client device. An application registration module receive requests for AppKeys, builds the AppKey and returns it to the caller.

The enrollment module computes the DMK and stores it in a (secure) database indexed by a Key ID.

The Key ID may be generated in a variety of ways, including the preferred embodiment of making it the cryptographic digest of the DMK. Note that the Device Authority's half of the DMK is chosen to ensure that the Key ID is unique. Other methods include having the Device Authority select the Key ID and sending the chosen value to the Device. The selection of the Key ID may use any of a variety of techniques, such as using sequential numbering, using an encrypted sequential counter, using pseudo random numbers, or using truly random numbers.

7. User Experience

This section discusses operations that the user can expect to perform when testing a system comprising the Device Authority. The basic concept is that the user will enroll a client device (exercising the enrollment module of the Device Authority), register an application and then create, edit, seal and unseal AppContainers on that device (exercising the application registration module of the Device Authority). The user can also send the AppContainers to the authentication server where they can be manipulated using the AppKey generated by the application registration module. The authentication server functionality is enabled by the Device Authority.

A typical setup is:

Client PC <--> Application registration and AppContainer transfer <--> PASS server

Client PC <--> Enrollment <--> Device authority server.

Presented below are the actions taken by the user to exercise the system.

Device enrollment on client is as follows. In order to enroll the device the user performs the following actions using the Client application. Typically, device enrollment happens rarely, such as once each time the device gets a new owner.

The user may test for enrollment. This is to ensure that the device has not previously been enrolled using the Test for enrollment option. If the device has been enrolled and the user wished to re-enroll then the Un-enroll option in the application is selected.

The user may select a device enrollement option. This option contacts a Device Authority which acts as an enrollment server and generates a DMK for the device. The DMK will be returned to the client PC and stored. Where it is stored depends on which version of the cryptographic system is being used. A dialogue then appears indicating that the device has been enrolled.

The user may be able to verify using the Device Authority's records that a new DMK has been created. The user can check using the enrollment user interface at the Device Authority to show that a new DMK has been created. In some alternatives, the Device will be enrolled by a separate user, such as a system administrator or system integrator

Application registration on the client is as follows. In order to proceed with the following actions the user must have an enrolled client device.

The user first initiates registration. The user selects the register option to initiate registration. The user at this point is prompted for an application/device identifier (ADID) for the combination of the application and device.

The registration request is sent via the authentication server to the application registration module. The application registration module generates an AppKey which it then returns to the authentication server. The registration module also returns an AppContainer with the correct Encrypted Owner's Code Digest.

The user may check the application registration module logs. The user checks using the application registration module user interface that an AppKey has been generated for the application.

The user may check the authentication server logs for registration. The user checks that the authentication server now has an AppKey for the instance of the application being run on the device.

The user may verify on a Client device that it now has an AppContainer. Through the AppContainer menu on the Client device the user sees a visible confirmation that he has an AppContainer.

AppContainer Operations

AppContainer operations on client are as follows. The following is a discussion of what a user can do on the client device with AppContainers. After registration the user will have one AppContainer on a device created by the authentication server.

Options provided on the Client allow the user to send an AppContainer to and request an AppContainer from the authentication server as described below. These options provide a method for demonstrating a typical transaction between client and authentication server. The best way to explain is with an example.

A user wants to add money to his virtual cash drawer on his client PC. The current balance is stored in an AppContainer. The user selects an Add Cash option in the Cash Drawer application and the AppContainer along are sent to an AddCash script running on the authentication server (run by a Cash Drawer provider). The AppContainer is opened, the data changed and then returned to the user, all of this probably in the same transaction.

In one embodiment of the system, the Device Authority customer has ability to see what is going on both on the client and the authentication server and manipulate AppContainers on his own, adding his own data and checking out logs etc at his own pace. So instead of one atomic transaction where an AppContainer is sent to the server, predefined data changed, and then returned to the client, functions are provided that let this work be initiated by the user from the client device. The user can select an option on the client to send an AppContainer to the server. The user can then go to the server, check that it is there, change some data in it and reseal it. The user can then go back to the client PC and GET the AppContainer back.

In the preferred embodiment of the present invention, the client pulls data rather than having the server push the containers back.

There is an AppContainer menu on the client application that allows the user to List AppContainers, Edit an AppContainer, Send an AppContainer to the authentication server, Get an AppContainer from the authentication server, Create an AppContainer, and Delete an AppContainer.

List AppContainers. All AppContainers are stored in a default directory on the Client device by the application. Selecting the List AppContainers option allows all containers to be displayed (possible with some data identifying the application that created them). The user can highlight an AppContainer in the list and then select one of the two following options:

Edit AppContainer. The application warns the user that the AppContainer is currently sealed and gives him the option to try and unseal it. If the unseal is successful then the contents of the AppContainer are displayed in a text box and are editable. If the user changes any of the AppContainer and then closes the AppContainer, he is given the option to Seal the AppContainer.

Send AppContainer to the authentication server. The user sends an AppContainer to the authentication server. This allows the user to go to the authentication server and attempt to manipulate the AppContainer.

Get AppContainer from the authentication server. The user can request a specific file from the authentication server. A subsequent Unseal operation authenticates that the AppContainer arrived unchanged and was created by the authentication server.

Create AppContainer. The user should be able to create his own AppContainers. When the user selects this option capabilities similar to the Edit AppContainer option as described above are available.

Delete AppContainer. This is not a cryptographic function but is available to help tidy the system up.

8. AppContainer Operations on the Authentication Server

The authentication server presents two user interfaces (AppKeys log and AppContainers) that allow the user to perform various tasks.

The AppKeys log is used to indicated to the user that something is actually happening when an AppKey is requested. It won't allow the user to modify the information. It may be a log viewer showing that an AppKey request was received from a client device with an identifier and that the AppKey was stored. It may indicate information such as date/time, IP address of requesting Client device: KID, resulting AppKey, etc.

The AppContainers user interface provides similar options to those of the Client device application. The user can List AppContainers, Create or Delete an AppContainer, Seal or Unseal an AppContainer, and Approve or Disapprove Application Registration.

List AppContainers lists all AppContainers stored on the authentication server along with the identifier of the Application that they belong to. Selecting an AppContainer brings up another page that provides the ability to edit the contents of the AppContainer.

Using Create AppContainer, the user creates AppContainers for the Client device (which the device could then request). The Delete AppContainer function is not a cryptographic function but is available to help tidy the system up.

The enrollment and the application registration modules have a user interface/log viewer that provides information on requested master keys, AppKeys, etc.

9. Cryptographic Design of the Device Authority Server

The Device, the Authentication Server, and the Device Authority server all have cryptographic service modules. This section focuses primarily on the needs of the Device Authority server.

The Device Authority server has its functionality split up to ease the protection of various components. The main idea is that unprotected keys never go onto any network. Its components include: keys, cryptographic libraries, and an enrollment code. The keys (DMKs, server PrivateKeys) are preferably stored in a host security module using some kind of secure hardware device. This device could be literally just an encryption/decryption hardware device, or it could be a specialized server with limited networking to limit potential attacks on it. The secure device combines cryptographic functions and a key database, perhaps optimized for secure access from the crypto functions. The cryptographic libraries provides the authentication servers with the necessary routines to perform the raw operations (encrypt, decrypt, etc.) on the various containers. The enrollment function generates DMKs, secrets that are among the most sensitive data in the system. The Enrollment code protects the DMKs and delivers them securely to the enrolling client device.

The logical layout of the cryptographic server is as follows.

Behind a firewall and load balancer are:

HTTP Server—Servers running Enrollment.protocolHandler (+container classes)

Behind another logical firewall to prevent unauthorized traffic to be received by the key server are:

Key Server with Key DB running Enrollment.getDMK (+container classes) and RSA-Bsafe Crypto Lib

The cryptographic server securely stores three private keys, for code signing, communication, and a root key. The root key is used to sign new lower level keys. These keys may be stored in an encrypted file that the cryptography module loads on startup.

The DMKs that are generated with the enrollment of each client are stored in a database. A Device Authority generates the DMK. This code receives a clientSeed and enrollmentMKKey in a PubKContainer (abbreviated as: public(mkc(clientSeed))) from a servlet/protocol handling portion of the enrollment. The clientSeed is combined via a cryptographic function such as SHA1 with a serverSeed to create the DMK. The DMK is sent back to the Device inside an MKContainer cryptographically sealed by the enrollmentMKKey.

The basic required functionality of the Device Authority is to handle enrollment requests. An enrollment protocol handler function (abbreviated as: enrollment.protocolHandler) gets containers from the network and passes them to the cryptographic server so that the enrollment DMK generation function (enrollment.genDMK) can do its job without exposing any key information to any other party.

10. Component Details

This section describes one of many possible embodiments.

Enrollment. From the Device Authority viewpoint, the process flow for enrollment is as follows.

(1) An enrollment servlet is invoked by a client.

(2) The enrollment servlet instantiates Enrollment Class on the secure server through RMI. InputStream is passed as an argument to an Enrollment Object on the secure server.

(3) The Enrollment Object on the secure server then proceeds to:

Construct a PubKContainer Class with the received InputStream as a constructor argument;

Get an Instance of MKContainer from the PubKContainer;

Extract the DMK Client seed from the MK Container;

Generate a random DMK server seed (i.e. the server part of DMK);

Concatenate SMClientSeed with DMKServerSeed to generate the master key. The concatenation is DMKClientSeed∥DMKServerSeed in that order;

Set the appropriate opcode and data (DMKServerSide) in the MK Container Object;

Generate a Key ID by performing a SHA1 on the master key formed in the previous step. This step may also ensure that the Key ID is unique;

Convert the master key and Key ID into BigIntegers and store them in the database. Seal the obtained MKContainer object;

Get the raw data in the form of array of bytes to be sent from the secure server to a Web server (i.e., to the calling enrollment servlet); and

The enrollment servlet converts the raw bytes into InputStream and sends it to the client as an Http response.

The above flow is for a simple embodiment. In a preferred embodiment, an acknowledgement servlet waits for a client response (that it has successfully received the DMKServer seed) and then updates the database table for permanent DMK.

11. Module Component Details

The Client application is an application typically running on a Microsoft Windows-based PC. In order for this application to use cryptographic functions it interfaces to a Kernel Mode device driver called by the operating system driver.

The application provides the following functions: Initialize, Test for Enrollment, Enroll the device, Register an application on the device, List AppContainers, Edit AppContainer, Save AppContainer, Post AppContainer to the authentication server, Get AppContainers from the authentication server, Create a new AppContainer, and Un-enroll the device.

As for initialization, when the application is invoked it automatically des the following: loads the operating system driver, and calls OsdRegisterApplication to have the application set up as a registered application.

In testing for enrollment, call OsdGetCapabilities checks a Capabilities parameter returned to see if the device has already been enrolled, and displays a dialogue indicating whether the device is enrolled or not.

To enroll the device call OsdEnrollGenerateRequest to get a sealed PubKContainer, and send an HTTP request to Device Authority Enrollment URL, pass the PubKContainer in the body of the request, check the response code to make sure the operation was successful. If successful pass the content returned as the MKContainer parameter in a call to OsdEnrollProcessResponse, and display a dialogue indicating whether the enrollment was successful or not.

To register an application on the device call OsdGetCapabilities and check the Capabilities parameter returned to see if the device has already been enrolled. If not then enroll the device as defined above. Prompt the user for a string identifying the Application/device combination (ADID). Create a PubKContainer which will be used for Registration. Send an HTTP request to the Device Authority RegisterApp URL and pass the PubKContainer and the ADID in the body of the request. Check the response code to make sure the operation was successful. If successful the resulting data should be an AppContainer. Store the AppContainer in a default directory.

The user can display a list of AppContainers stored in the default directory with the ability to highlight an AppContainer.

The Client application provides the ability (through menu options, buttons, etc.) to: edit the highlighted AppContainer, delete the highlighted AppContainer, send the highlighted AppContainer to the authentication server, and create a new AppContainer

To edit an AppContainer, first Unseal the AppContainer, by calling an OsdAppContainerUnseal function, passing the contents of the AppContainer file pContainerBuffer parameter, and if the OsdAppContainerUnseal is unsuccessful then display an error dialogue. Parse the AppContainer structure to get to the Data field. Display the contents of the AppContainer in an edit box allowing the user to change the data. Provide the ability to save or discard the changes to the AppContainer.

To save an AppContainer, seal the AppContainer, reconstruct the AppContainer structure, call the OsdAppContainerSeal function, passing the contents of the unsealed AppContainer structure in the pContainerBuffer parameter, and if the OsdAppContainerSeal is unsuccessful then display an error dialogue. Save the sealed AppContainer structure to file.

To post an AppContainer to the authentication server, send an HTTP request to the URL for the HeresAnAppContainerForYa function passing the contents of the highlighted AppContainer file in the body of the request, and check the status of the HTTP Request and display a dialogue with success or fail

To get an AppContainers from the authentication server a dialogue box is provided to allow the user to select the file on the server that is to be download. an HTTP request is sent to the URL for the OiGiveMeAnAppContainer function passing the contents of the requested AppContainer file in the body of the request. The status of the HTTP Request is checked and display a dialogue with success or fail. If a file is going to be overwritten then prompt the user to overwrite the original.

To create a new AppContainer, open an existing AppContainer file, unseal the AppContainer and zero the datablock, and allow the user to edit the data and then follow the Save AppContainer function (saving the file as a new filename specified by the user).

To un-enroll the device call OsdRegisterApplication to have the application set up as a registered application. call OsdGetCapabilities to check the Capabilities Word returned to see if the device has already been enrolled. If the device has already been enrolled call OsdInvalidateDMK.

The functionality provided by the authentication (PASS) server is as follows. The authentication server can register a device/Application combination. The client device sends a request to the URL of the OiRegisterMe function with a PubKContainer and ADID in the body of the request. The authentication server sends and forwards the request to the ARM server. The ARM server generates and returns an AppKey which should be stored by the authentication server against the ADID. The authentication server then creates an AppContainer using the newly generated AppKey and send it back to the client device. This will complete registration. All of the above is done in a single transaction between Client, authentication server and application registration module.

The authentication server provides a user interface to manipulate AppContainers (Create, Edit, Seal and Unseal) through a user interface. The authentication server provides a user interface which allows the user to manipulate AppContainers. This may be done using HTML and Java Servlets with code written in Java to allow AppContainers to be sealed, unsealed, etc. Pages are required to List and Edit AppContainers as defined in the section on the application running on the client.

The authentication server can receive AppContainers from the Client device. The Client device has a function that allows it to send AppContainers to the authentication server. An entry point exists on the authentication server to allow this to happen. This can be done using a servlet that reads from the input stream and stores the data in a file along with a filename, or even simpler by enabling the PUT method of HTTP on the authentication server.

12. Containers and Keys

A container is structure that is used to hold information. This information can be signed and/or encrypted. To increase security various types of containers are available. Some of those containers are only used for signed data. Some containers hold encrypted data. Even within the encrypted containers they are several subtypes that depend on the encryption algorithms used. There are four kinds of containers.

A SignedContainer holds data that is digitally signed by a private key (from the signing Key-pair) and can be verified with the matching public key (on the clients the public key is stored in ROM/flash). These are used to send authenticated data from the Device Authority server to the client machines and to authorize software modules to use the Device Authority client services.

An AppContainer is a protected container that can only be read or written by a specific application program running on a specific machine. These containers identify the program that sealed them and it is possible to allow another program to unseal a container, so they can also be used as a secure form of inter-process communication. High-level security functionality like detecting virus modifications, software licensing and secure wallets can be built on top of AppContainers. Generally the AppContainer is bound to a given machine by using a derivative of the DMK for encryption.

A PubKContainer is a digital envelope that is sealed by the client (OSD) with an RSA public key (from the Communication Key-pair and can only be read by a recipient (generally the Device Authority server) with the matching private key. These are used during enrollment and for setting up an encrypted channel between the client and an authenticated Device Authority server. The data inside this container is encrypted with a 128-bit c cipher key (also called a Master Key within this product) that is randomly generated by the operating system driver. The RC6 key (Master Key) and the client's Key ID (KID) is encrypted with the recipient's public key (server's Communication PubKey).

An MKContainer is used as part of a digital envelope based on a master key (created by the client and sent in a PubKContainer) that is known to the writer and reader of this container. These can be used to secure communications between the client and the Device Authority server after the master key is sent to the server via a PubKContainer. These can also be used to protect data locally on the client machine.

These container structures have a set of predefined operations that can be performed on them. These operations are seal and unseal.

Sealing can be signing without encrypting (Oust like a diploma has the seal of a university but everybody can read the content of the diploma). Sealing can also be encrypting Oust like the envelope containing the winner of an award is sealed so that no one can look at the contents without unsealing).

Unsealing is reversing the seal operation. This can be verifying that the seal is original Oust like the seal on the diploma, there are certain features that are almost irreproducible that can be verified). Unsealing can also be exposing the hidden content (in the case of the award, getting to the hidden content is fairly easy).

Each container structure is described below. The container structure is shown in its unsealed version followed by a description of the sealing operation. Then the sealed structure is shown followed by description of the unseal operation. If an operation fails for any reason, it zeroes the container.

The following list itemizes the functions provided by the present invention. A small set of container types support: (a) communication security, (b) system integrity, and (c) application specific protected containers. The functions provided by the present invention allow one to create a DMK between the client and Device Authority server to allow the creation of data containers or commands that are only meaningful on a specific device, control access to data based on the identity of the program rather than the user, authenticate that information came from an authorized Device Authority server, authenticate that information came from a specific device, support protected execution environments for application programs that need to keep tamper proof secrets, and support data storage areas that can only be overwritten by specific programs.

13. Overview of the Design of the Present Invention

Protected containers are implemented by low-level BIOS code and OS-layer driver (OSD) code (e.g., a VXD under Win98). Some of the BIOS code runs during POST to set up information in the System Management memory (SMRAM) that is used by routines invoked via System Management Interrupts (SMI). The SMI routines perform RSA operations using public keys from the flash ROM, which are therefore very hard to tamper with. The SMI routines also hide and manage the DMK which is a secret RC6 key known to the device and to the Device Authority server. The cryptographic primitives derive multiple(keys from this single 128-bit master key with each key being used for a single purpose. The SMI routines authenticate their caller and will only perform services for an authorized operating system driver module.

All clients know the public key of the server, so they can verify that the server signed a message, since the server is the only one who knows the matching private key. The DMKs are unique to each device and known only to that device and the server. If a message is properly protected by the DMK, then the message must have come from either the server or the client that has that unique DMK. The clients identify themselves using a 20-byte Key Identifier, that is the SHA1 digest of the DMK. The SHA1 function is one-way in the sense that knowing the Key ID will not help the attacker find the DMK, other than trying each possible master key to see if it produces the observed Key ID. There are too many DMK values (2 to the 128th power) for this approach to be practical.

The AppContainers are secured with the help of the DMK. Each container is encrypted with a key that is a function of the DMK and the digest of the code of the program that owns the container. The design ensures that the SMI level code will only unseal a container for the program that created the container. The Device Authority server must be involved with creating the first container for a particular program on a specific machine.

The mid-level operating system driver code supports the container abstractions and performs operations that are not possible for the SMI routines. For example, the SMI routines cannot take page faults, so the operating system driver routines must copy parameters into locked memory before calling the SMI routines. The operating system driver routines can also run for a longer period of time than the SMI routines.

The protocols used to support security features in this release rely heavily on the four kinds of containers described in this document. For example, the enrollment protocol that creates the master key is based on exchanging these containers with the Device Authority server.

14. Use of Keys

The keys that exist and how they are used to establish trust and security will now be discussed.

The system uses cryptographic keys to provide privacy, integrity and authentication of programs and data both on the client system itself, and between the clients and Device Authority server.

Public/Private Keys Pairs are employed in the present invention. Public/private key-pairs are used to securely transact data that does not need to be associated with a particular client system. These are used mainly to ensure that data transferred from any client to the Device Authority server and vice-versa is authentic and will facilitate that data is private (encrypted). These keys are included in ROM at manufacture time.

The Device Authority server holds the private keys of three RSA key-pairs that are used for different purposes and are stored in different places in the server environment. Client systems hold the public keys of these key-pairs and are stored in ROM. For standard (strong) cryptography 1024-bit versions of each of these key-pairs are used. The three key-pairs are:

Root Key-Pair. The private key is stored in a machine controlled by a Device Authority that is not attached to the Internet. The matching public key is stored in the ROM of the client machines. The private root key is used to sign new public keys which are then sent to the client machines to replace stale public keys. The method of replacing the old keys in ROM is outside the scope of this document. These root keys will be used infrequently. The public key is used in the client system with signed containers.

Server Communication Key-Pair. This is also called an enveloping key-pair and is used for dynamic data signing. The private key is stored on the Device Authority server and used to establish secure communication with a client. The private key can be used to unseal keys (and any other data) sent by the clients, or to sign dynamically created messages that will be verified by the clients. It is used with PubKContainers. All the clients have a copy of the matching public key stored in their BIOS ROM.

Signing Key-Pair. The private key is stored on a Device Authority signing machine that is not directly accessible from the Internet. The private key is used to sign downloaded files (programs and configuration data) that are then placed on the Device Authority server and eventually sent to the client machines. All the client machines have the matching public key, so they can verify signatures created by the private key. The signing key-pair is used to strongly authenticate static information such as new releases of software components. Since the private key is not accessible from the Internet, it is easier to protect.

The public key is used in the client system with signed containers. It is possible to use only one key-pair for all of the above operations. However, using several key-pairs for different purposes is an inexpensive and easy way to decrease the chance of an attack from successfully breaking the entire system.

Secret keys. The following keys are symmetric keys, in that the same key is used to both encrypt and decrypt.

A Master Key (MK) is used as a base for creating Symmetric Keys used in encrypting/decrypting. These keys are generally used during a single communication between the client and the server. They are equivalent to session keys.

A DMK is used to securely transact data that needs to be associated with a particular client system. The DMK is unique and is used to authenticate the client system. The DMK is important as it uniquely identifies the client system. It is a used as a base for creating other Symmetric Keys used in encryption/decryption algorithms. The DMK is created and sent to the client by the Device Authority server during the enrollment process.

The device master key is only accessible by the Device Authority Server and the cryptographic ROM component on the client system. The ROM component runs in SMM, which is a special mode for x86 processors that cannot be traced into by ordinary software debuggers.

The DMK is used on the client system to seal and unseal AppContainers. The DMK is bound to one machine and must not be transferable (except if transferred first to the Device Authority server and then to another client). The DMK should never be exposed in regular system memory. It should therefore never be passed up to the operating system driver level where it could be captured by a hacker and transferred to another machine. The operation to seal and unseal the AppContainer must be executed strictly in SMRAM. All other operations to seal and unseal may be preformed by the operating system driver layer.

A Key Identifier (KID) is a one-way SHA-1 digest of the DMK. The Key ID is used to identify the client in a message sent from the client to the server. The header of a message from the client will include the Key ID, which the server will use to index into the DMK database tables to find the symmetric key to the client's master key, which in turn is be used to derive the key needed to decrypt the rest of the message. When the enrollment process has not yet assigned the DMK, the DMK is replaced with a temporary random value until it the true DMK replaces it.

A certain number of derived Keys are generated based on the DMK and other Master Keys. The primitives for deriving Keys show how these derived keys are generated based on the Key usage values described below.

Key Usage Values. This section enumerates the key usage values that are part of this design. These values are used with the NewKey( ) function and the Enc( )Dec( )functions. These functions are used during sealing and unsealing of the various containers. Usages are different for the client and the servers (which complicates playback and self-playback attacks).

| Usage name | Comment |
|---|---|
| UsageAppCodeDigest | This is used to create the encryption key for |
| | the AppCodeDigest field of an |
| | AppContainer |
| UsageAppEncServer | This is used to create the encryption key for |
| | an AppContainer created by the server |
| UsageAppEncClient | This is used to create the encryption key for |
| | an AppContainer created by the client |
| UsageAppMacServer | This is used to create the HMAC key for an |
| | AppContainer created by the server |
| UsageAppMacClient | This is used to create the HMAC key for an |
| | AppContainer created by the client |
| UsageMKEncServer | This is used to create the encryption key for |
| | an MKContainer created by the server |
| UsageMKEncClient | This is used to create the encryption key for |
| | an MKContainer created by the client |
| UsageMKMacServer | This is used to create the HMAC key for an |
| | MKContainer created by the server |
| UsageMKMacClient | This is used to create the HMAC key for an |
| | MKContainer created by the client |

The keys used in AppContainers are split into three parts. One important feature of AppContainers is that the AppKey( ) used to create them is a function of both the DMK (i.e., a unique identifier of the client device) and the application Code digest (i.e., a unique identifier of the software that “owns” container. AppContainers are bound to a specific program on a specific device. The last part of the key is not known to the Device Authority (unlike the DMK) neither to the general public (unlike the Application Code Digest). This last part is called the CustomerSecret. Any value for that key can be used to seal the AppContainers. But it is advised to use strong 128 bit random value (just as strong as the DMK).

The CustomerSecret part allows a company to discard compromised application Containers without having to get a new build for the application that would produce a different Application Code Digest. Also, this CustomerSecret allows a given instance of an application (e.g. secure logon application) on a device to securely share data with more that one server. Each server would setup a unique CustomerSecret with that same application on the same device. Thus, the sealed AppContainers could only be decrypted if the correct CustomerSecret is provided.

The CustomerSecret is intended to be shared between the specific client application and one of many servers that the client application connects to.

It is possible for the Device Authority server to delegate the authority to create AppContainers to a specific vendor of software by giving that vendor a list of AppKey values for the devices that are enrolled with the Device Authority. The AppKey is a cryptographic one-way function of the DMK and Application Code Digest, so the vendor can be given these keys without enabling the vendor to create containers for other applications or without making it easy for the vendor to figure out the master key for a given device.

15. Container Opcodes and Formats

All containers have a common 4-byte header that includes an opcode byte (command or message type), a format byte, and a length word (16-bit) of the following content. The format byte indicates which of the four types of containers is present so the low-level routines know what kind of cryptographic operations needs to be performed. The format byte would change if the cryptographic algorithms changed in a future release. The opcode byte expresses the kind of higher-level data that is inside the container. The low-level routines use some of the opcode values (e.g., for containers used during the enrollment protocol), but most are available for use by the high-level code or future releases. The length field identifies the number of bytes (after the header) that belong to the container. The header is not encrypted, but it is protected by a cryptographic checksum that is part of every container.

This section enumerates the defined container opcode and the format of the containers that have that opcode. In the current release each opcode implies a specific container format, though this may change in the future. The purpose of having both an opcode field and a format field is to simplify the layering of the code and allow for future changes in the suite of cryptographic algorithms, or for changes in the content of the data required for a particular operation.

The format byte can have one of the following values:

| Format Code | Value | Description |
|---|---|---|
| FmtSignedContainer | 1 | Container is a Signed |
| | | Container |
| FmtAppContainer | 2 | Container is a App |
| | | Container |
| FmtPubKContainer | 3 | Container is a PubK |
| | | Container |
| FmtMKContainer | 4 | Container is an MK |
| | | Container |

The following are values of the Op Codes

| Op code name | Value |
|---|---|
| OPC_OSD_AUTHORIZATION | 0x01 |
| OPC_OSD_ALLOW_TRANSFER | 0x02 |
| OPC_MK_KEY | 0x03 |
| OPC_INITIAL_APP_CONTAINER_FROM_SERVER | 0x04 |
| OPC_CUSTOM_APP_CONTAINER_DATA | 0x05 |
| OPC_CHALLENGE_RESPONSE_FROM_CLIENT | 0x06 |
| OPC_DMK_ENROLL_REQUEST_OUTER | 0x07 |
| OPC_NEW_CONNECTION | 0x08 |
| OPC_DMK_ENROLL_REQUEST_INNER | 0x09 |
| OPC_DMK_ENROLL_RESPONSE | 0x0a |
| OPC_CLIENT_TO_SERVER_WRITE | 0x0b |
| OPC_SERVER_TO_CLIENT_WRITE | 0x0c |
| OPC_CHALLENGE_REQUEST_FROM_SERVER | 0X0e |

16. Opcodes for SignedContainers

The SignedContainer holds data that is digitally signed by a private key (from the Signing Key-pair) and can be verified with the matching public key (on the clients the public key is stored in ROM). These are used to send authenticated data from the Device Authority server to the client machines and to authorize software modules to use the client services.

16.1 Opcode: OipcOsdAuthorization Container: FmtSignedContainer

This container is used to authorize a program to use some or all of the functions in the operating system driver security module. It has the following fields in the data portion of the container:

| Field | Length | Description |
|---|---|---|
| NStartOffset | 4 bytes | Starting offset of calling |
| | | code |
| NEndOffset | 4 bytes | Ending offset of calling |
| | | code |
| CodeDigest | 20 bytes | Code Digest of calling code |
| PrivilegeBitVector | 8 bytes | Privilege Bit field. This |
| | | vector indicates what |
| | | functions the application is |
| | | allowed to invoke. |

16.2 Opcode: OpcOsdAllowTransfer Container: FmtSignedContainer

This container is used to authorize a program to transfer an AppContainer to another application on this machine. It has the following fields in the data portion of the container:

| Field | Length | Description |
|---|---|---|
| CallersAppCodeDigest | 20 bytes | Caller's ACD |
| RecipientsAppCodeDigest | 20 bytes | Recipient's ACD |

16.3 Opcode: No OpcBiosAuthorization No FmtSignedContainer

This is not a container but is a number of bytes that are encrypted by the servers Private Signing Key. They are not stored in any kind of container. These bytes are used by the operating system driver when it registers itself with the BIOS using the BIOSRegisterOSD( ) function.

| Field | Length | Description |
|---|---|---|
| NStartOffset | 4 bytes | Starting offset of calling |
| | | code |
| NendOffset | 4 bytes | Ending offset of calling |
| | | code |
| CodeDigest | 20 bytes | Code Digest of the |
| | | operating system driver |

17. Opcodes for AppContainers

The AppContainer is a protected container that can only be read or written by a specific application program. These containers identify the program that sealed them and it is possible to allow another program to unseal a container, so they can also be used as a secure form of inter-process communication. High-level security functionality like detecting virus modifications, software licensing and secure wallets can be built on top of AppContainers. Generally the AppContainer is bound to a given machine by using a derivative of the master key for encryption.

17.1 Opcode: OpcMKKey FmtAppContainer

This container holds a key that can be used in MKContainer operations. This container is normally returned by OsdPubKcontainerSeal( ) during the creation of a PubKContainer. MKContainer operations require this container.

17.2 Opcode: OpcInitialAppContainerFromServer Container: FmtAppContainer

This container is empty and is used as a template for the application to create other AppContainers. The only significant field in it is the encrypted AppCodeDigest. The sealers code digest field is null in this case. All the bits of the CustomerSecret used to seal this AppContainer are zero.

17.3 Opcode: OpcCustomAppContainerData Container: FmtAppContainer

This container is empty and is used as a template for the application to create other AppContainers. The only significant field in it is the encrypted AppCodeDigest.

17.4 Opcode: OpcChallengeResponseFromClient Container: FmtAppContainer

This container holds the challenge response from the client to the server. It holds the servers challenge random number (Rs). This container is used in response to an MKContainer with OpcChallengeRequestFromServer.

| Field | Length | Description |
|---|---|---|
| Rs | 16 bytes | 128-bit random value |
| | | provided by the server. Or |
| | | KID \|\| MK when used as an |
| | | acknowledge for the |
| | | enrollment. |

18. Opcodes for PubKContainers

The PubKContainer is a digital envelope that is sealed by the client (OSD) with an RSA public key (from the Communication Key-pair and can only be read by a recipient (generally the Device Authority server) with the matching private key. These are used during enrollment and for setting up an encrypted channel between the client and an authenticated Device Authority server. The data inside this container is encrypted with a 128-bit RC6 cipher key (also called a Master Key within this product) that is randomly generated by the operating system driver. The RC6 key (Master Key) and the client's Key ID (KID) is encrypted with the recipient's public key (server's Communication PubKey)

18.1 Opcode: OpcDMKEnrollReguestOuter Container: FmtPubKContainer

This container is used during enrollment.

18.2 Opcode: OpcWDLNewConnection Container: FmtPubKContainer

This container is used by the client application to set up a new encrypted channel. The first part of this container may be reused to avoid RSA operations. It has the following fields in the data portion of the inner MKContainer.

| Field | Length | Description |
|---|---|---|
| MK | 16 bytes | 128-bit fresh random |
| | | connection master key. |

19. Opcodes for MKContainers

The MKContainer is used as part of a digital envelope based on a master key (created by the client and sent in a PubKContainer) that is known to the writer and reader of this container. These can be used to secure communications between the client and the Device Authority server after the master key is sent to the server via a PubKContainer. These can also be used to protect data locally on the client machine.

19.1 Opcode: OpcDMKEnrollRequestInner Container: FmtMKContainer

This container is used during enrollment. It has the following fields in the data portion of the container.

| Field | Length | Description |
|---|---|---|
| DMKClientSeed | 20 bytes | Seed used to generate the |
| | | master key |

19.2 Opcode: OpcDMKEnrollResponse Container: FmtMKContainer

This container is used during enrollment. It has the following fields in the data portion of the container.

| Field | Length | Description |
|---|---|---|
| DMKServerSeed | 26 bytes | Seed returned from Server |
| | | used to generate the master |
| | | key |

19.3 Opcode: OpcClientToServerWrite Container: FmtMKContainer

This container is used by some client application to send data to the server (i.e., data written by the client).

| Field | Length | Description |
|---|---|---|
| Data | 0-64000 bytes | Client specific data |

19.4 Opcode: OpcServerToClientWrite Container: FmtMKContainer

This container is used by some client application to receive data from the server (i.e., data written by the server).

| Field | Length | Description |
|---|---|---|
| Data | 0-64000 bytes | Client specific data |

19.5 Opcode: OpcChallengeRequestFromServer Container: FmtMKContainer

This container is sent by the server to establish authenticity of the client system. The response to the container is in a OpcChallengeResponseFromClient.

| Field | Length | Description |
|---|---|---|
| Rs | 16 bytes | 128-bit random value |
| | | provided by the server. |

Other Opcodes may be defined for new applications. Applications using the system application program interfaces may have to comply and use the Opcodes provided to them by a Device Authority.

20. Format and Creation of AppContainer

Once a program has one AppContainer it can create copies of that container and then fill those copies with different information. However, the only way to get the first AppContainer is to have the Device Authority server create one for this specific program on this specific machine. This is related to the AppCodeDigest.

The AppContainer is used to store a symmetric key called a Master Key. This Container is then passed to functions that perform sealing/unsealing operations that require a Master Key. The AppContainer is also used to store information specific to an application that is specific to a given machine that is identified by its SharedMasterKey that was assigned during enrollment. This application can share information with many servers on a one-on-one basis where each server can only decrypt its own AppContainer.

An unsealed AppContainer has the following format. The steps involved in sealing the container add 21 to 36 bytes of information to the end (MAC and Padding), so the caller must ensure that the buffer is big enough to hold the larger sealed format otherwise the seal operation will return an error. The SealerscodeDigest and Initialization Vector (IV) are all filled in by the seal operation. The Initialization Vector is a random number used in Cipher block chaining. In CBC, the IV is first XORed with the first block of plaintext before it is encrypted with the key. The AppCodeDigest is taken from an original AppContainer provided by a Device Authority. The AppContainer Structure is shown in Table 1.

Sealing an AppContainer. The encryption is done with derivatives of the master key, AppCodeDigest, and CustomerSecret (all 128 bits can default to zero most of the time).

Operating system driver sealing. This operation prepares the data to be sealed by the bios. It requires that an original AppContainer that has been provided by a Device Authority. This original AppContainer contains an encrypted AppCodeDigest that has been encrypted for this specific client system using the master key for this specific client system).

Confirm that the device has a valid DMK. If not return error. Confirm that the Length is acceptably small. This is the length of the container starting with and including the AppCodeDigest field and ending with and including the Data field. Confirm that Format equals FmtAppContainer. Set the Initialization Vector to random value passed in by the operating system driver security module. Set SealerscodeDigest to a value calculated by the operating system driver security module based on the caller's authorization information provided during OsdRegisterApplication( ). Structure modifications during operating system driver AppContainer sealing are shown in Table 2.

BIOS AppContainer sealing is the final stage before the data is sealed.

Let DecryptedCodeDigest=Dec160Bits (AppCodeDigest). The AppCodeDigest in the container is not changed by the seal operation. This allows an application to create new AppContainers based on the original AppContainer provided by a Device Authority.

Confirm that DecryptedCodeDigest equals the to the CallersCodeDigest value determined by the operating system driver security module.

Let Key=CustomerAppKey(AppKey(DMK, AppCodeDigest), CustomerSecret) where CustomerSecret is the value passed down by the operating system driver.

Let Payload=Opcode∥Format∥Length∥AppCodeDigest∥IV∥SealersCodeDigest∥Data.

Set Mac=HMAC (NewKey(Key, UsageAppMac), Payload).

Set Padding to a vector of 1 to 16 bytes to make the variable, Plaintext, (see below) be a multiple of 16 bytes long. Each padding byte has a value equal to the number of padding bytes in the vector.

Let Plaintext=IV∥SealersCodeDigest∥Data∥Mac∥Padding.

Let Ciphertext=Enc (Key, UseageAppenc, Plaintext). Notice that the length of Ciphertext will be the same as Plaintext.

Overwrite all the fields after the AppCodeDigest with the Ciphertext. That is, replace all the bytes that made up Plaintext with the bytes of Ciphertext.

Set Length to the number of bytes in Plaintext plus 20 (for AppCodeDigest).

Structure Modifications during SMI AppContainer sealing are shown in Table 3. After the BIOS has sealed the Sealed AppContainer structure it has the format shown in Table 4.

Unsealing an AppContainer will now be discussed. The operating system driver unsealing operation gathers information required by the BIOS to unseal the container. The Length field is verified to insure that it is in an acceptable range, representing the length of the container including the Mac and padding. The OSD confirms that Format equals FmtAppContainer, and calculates the CallersCodeDigest based on the caller's authorization information provided during OsdRegisterApplication( ).

BIOS unsealing operates to unseal the data. The BIOS unsealing operation performs the following steps.

Confirm that the device has a valid master key. If not, return error.

Let DecryptedCodeDigest=Dec 160Bits (AppCodeDigest). The AppCodeDigest in the container is not changed by the unseal operation.

Confirm that DecryptedCodeDigest equals the to the CallersCodeDigest value determined by the operating system driver security module.

Let Key=CustomerAppKey(AppKey(DMK, AppCodeDigest), CustomerSecret) where CustomerSecret is the value passed down by the operating system driver.

Let Ciphertext=data after AppCodeDigest up to Length minus 20 bytes.

Let Plaintext=Dec (Key, UsageAppEnc, Ciphertext).

Replace Ciphertext bytes with Plaintext bytes to reveal unsealed fields.

Set Length=Length minus 20 minus length-of-Padding.

Let Payload=Opcode∥Format∥Length∥AppCodeDigest∥IV∥SealersCodeDigest∥Data.

Let ExpectedMac=HMAC (NewKey(Key, UsageAppMac), Payload).

Confirm that Mac equals ExpectedMac.

21. Format and Creation of MKContainer

First the unsealed format will be described and then the steps to seal and unseal it will be described. The MKContainer is primarily used to protect large (up to 64K) chunks of information sent between the client and server after they have set up a common Maser Key using a PubKContainer.

The MKContainer is mainly used to encrypt data. The encryption is based on a symmetric key encryption. This key is derived from a Master Key. The MKContainer can be used to encrypt large chunks of data (up to 64K) using a symmetric key derived from a Master Key. Special case uses are to encrypt transmissions between the client and a server during enrollment to allow setting up of the DMK, and encrypt transmissions between some client application and the Device Authority server.

The unsealed MKContainer structure will now be discussed. The MKContainer is very similar to the AppContainer. The main difference is that the AppCodeDigest is replaced with the digest of a Master Key that has been setup. The SealedCodeDigest will be zero for MKContainers created by the server. For containers created on the client, the SealersCodeDigest identifies the program that sealed this container.

The cryptographic operations on an MKContainer are performed by the operating system driver module rather than the SMI module. The operating system driver may use the SMI module to seal and unseal the master key, but all the encryption and integrity checking are performed by the OSD code.

An unsealed MKContainer has the following format. The steps involved in sealing the container will add 21 to 36 bytes of information to the end (Mac and Padding), so the caller must ensure that the buffer is big enough to hold the larger sealed format otherwise the seal operation will return an error. The MKDigest, SealersCodeDigest and IV are all filled in by the seal operation. Table 5 shows the MKContainer Structure

The encryption is done to seal an MKContainer with derivatives of Master Key passed in an AppContainer (that was created when calling OSDPubKContainerSeal( ))

The steps required to seal the OSD MKContainer container are as follows. These steps operate on the buffer in-place and thus overwrite the unsealed plaintext data. Note that the Usage values will be different for containers sealed by the client and server as explained in the section on usage values.

The sealing operation requires that an AppContainer with a master key be used. The sealing steps are as follows.

Confirm the Length is acceptable. This can be larger than AppContainers since the operation is performed by the operating system driver. This is the length of the container starting with and including the MKDigest field and ending with and including the Data field.

Confirm that Format equals FmtMKContainer.

Set MKDigest value to the SHA1 of the content of the unsealed AppContainer holding the MK.

Set IV to random value passed in by the operating system driver security module.

Set SealersCodeDigest to value determined by the operating system driver security module.

Let Key=Master Key passed in by the operating system driver security module.

Let Payload=Opcode∥Format∥Length∥MKDigest∥IV∥SealersCodeDigest∥Data.

Set Mac=HMAC (NewKey(Key, UsageMKMac), Payload).

Set Padding to a vector of 1 to 16 bytes to make the variable, Plaintext, (see below) be a multiple of 16 bytes long. Each padding byte has a value equal to the number of padding bytes in the vector.

Let Plaintext=IV∥SealersCodeDigest∥Data∥Mac∥Padding.

Let Ciphertext=Enc (Key, UsageMKEnc, Plaintext). Notice that the length of Ciphertext will be the same as Plaintext

Overwrite all the fields after the MKDigest with the Ciphertext. That is, replace all the bytes that made up Plaintext with the bytes of Ciphertext.

Set Length to the number of bytes in Plaintext plus 20 (for MKDigest).

Table 6 shows the structure modifications during OSD MKContainer sealing.

The structure of the sealed MKContainer is shown in Table 7.

Unsealing an MKContainer involves operating system driver unsealing.

The steps required to unseal the MKContainer container are as follows. Errors should zero the container. The unsealing operation requires that an AppContainer with a Master key be used. The unsealing steps are as follows.

Confirm the Length is acceptable. This is the length of the container including the Mac and Padding.

Confirm that Format equals FmtMKContainer.

Confirm that MKDigest equals value passed by the operating system driver module.

Let Key=Master Key passed in by the operating system driver security module via an AppContainer.

Let Ciphertext=data after MKDigest up to Length minus 20 bytes.

Let Plaintext=Dec (Key, UsageMKEnc, Ciphertext).

Replace Ciphertext bytes with Plaintext bytes to reveal unsealed fields.

Set Length=Length minus 20 minus length-of-Padding.

Let Payload=Opcode∥Format∥Length∥MKDigest∥IV∥SealersCodeDigest∥Data.

Let ExpectedMac=HMAC (NewKey(Key, UsageMKMac), Payload).

Confirm that Mac equals ExpectedMac.

22. Format and Processing of a SignedContainer

First the unsealed format will be described and then the steps to seal and unseal it will be described. These containers are primarily used to send authenticated information from the server to the clients. For example, these containers are used to authorize a program to call some of the functions of the operating system driver security module. They can also be used to send a list of filenames and the expected SHA1 digest of each file (e.g., to confirm that downloaded data is authentic). They can be used whenever the client needs to know that certain information or commands really did come from the Device Authority server.

The SignedContainer is used to confirm that downloaded data is authentic, confirm that data did come from the Device Authority server, and hold Authorization information for an application that is registering with the operating system driver. Table 8 shows the SignedContainer Structure.

Sealing a SignedContainer will now be discussed. The encryption is done with: Server signing Private key. The steps required to seal the SignedContainer container are as follows. These steps operate on the buffer in-place and thus overwrite the unsealed plaintext data. In the disclosed embodiments, the Device Authority server performs these steps to seal a SignedContainer.

Confirm that the selected private key is known. If not return error.

Confirm the Length is acceptable. Before sealing, the length includes the PublicKeyDigest and the Data.

Confirm that Format equals FmtSignedContainer.

Set PublicKeyDigest to the SHA1 digest of the public key that matches the selected private key.

Let Payload=Opcode∥Format∥Length∥PublicKeyDigest∥Data. Notice that this includes the unsealed length.

Let ExpectedDigest=SHA1 (Payload).

Set SigRSABlock=108 Zero bytes∥ExpectedDigest

Perform PKCS #1 version 2 signature padding on SigRSABlock. This is the same as PKCS #1 version 1 signature padding. This padding adds a fixed sequence of bytes in front of the Digest value to indicate that the ExpectedDigest value is the result of a SHA1 operation. It also replaces most of the zero padding bytes with 0xFF bytes.

Encrypt SigRSABlock with the selected private key.

Set Length=Length plus 128 to include the SigRSABlock size

After the server has sealed the SignedContainer structure it has the format shown in Table 9.

Unsealing a SignedContainer will now be discussed. The steps required to unseal the SignedContainer container are as follows. The client will perform these steps to validate the signature on this kind of container.

Confirm that the selected public key is known to the SMI routines. If not return error. Confirm the Length is acceptable. Before unsealing, the length includes the PublicKeyDigest, Data and SigRSABlock. Confirm that Format equals FmtSignedcontainer. Call BIOS to Decrypt SigRSABlock with the selected public key. Confirm that the PKCS #1 padding is correct for a signature using the SHA1 digest function. Let ExpectedDigest=the last 20 bytes of the decrypted SigRSABlock. Set Length=Length minus 128 to remove the SigRSABlock size. Let Payload=Opcode∥Format∥Length∥PublicKeyDigest∥Data. This includes the unsealed length. Let Digest=SHA1 (Payload). Confirm that Digest equals ExpectedDigest

As for BIOS unsealing, the BIOS does not work on the container itself. It is only invoked to decrypt the SigRSABlock.

23. Format and Creation of a PubKContainer

First the unsealed format will be described and then the steps to seal and unseal it will be described. These containers are primarily used to set up a secure communication channel between the client and the Device Authority server. The second part of the PubKContainer is a complete MKContainer object including the 4-byte header. The first part of the PubKContainer includes the value of the generated master key (MK) and the client's Key ID (KID) (or zeros if the master key has not been assigned), and both values are encrypted with the recipient's public key.

The format of the PubKContainer is carefully chosen to allow changing the second part of this container without changing the first part. This allows the client and server to implement some significant performance improvements. The OSD sealing function will return the generated master key wrapped in an AppContainer. The client could store and reuse the MK and the first part of the PubKContainer each time it starts a new connection to the server (e.g., to fetch a new download) and the second part will be an MKContainer that contains a new master key for encrypting this session. This avoids the need to perform a public key operation with the SMI routines and yet gets the security benefits of knowing that only the real server will know the new session key, since only the real server knows the saved master key (needed to decrypt the new session key) or knows the private key to read the first part. The important optimization for the server is to cache the master key that it extracts out of the first part of the PubKContainer and to index that cached value by the hash of the first part. This cache avoids the need to perform a private key operation when the first part of the PubKContainer is reused. The server can flush cache entries at any time because the client always sends the whole first part and thus the server can always use its private key (server Communication Private Key) to extract the master key. This also means that there is only one format for the initialize message between the client and server, not two separate formats to handle either reusing or creating an master key.

Uses for the PubKContainer are to setup transmissions between-the client and a server during enrolment to allow setting up of the DMK, and setup transmissions between some client application and the Device Authority server.

An unsealed PubKContainer has the format shown in Table 10. The steps involved in sealing the container will add 21 to 36 bytes of information to the end (Mac and Padding), so the caller must ensure that the buffer is big enough to hold the larger sealed format otherwise the seal operation will return an error. The SealedCodeDigest and Initialization Vector (IV) are all filled in by the seal operation.

Sealing a PubKContainer will now be discussed. The encryption is done with derivatives of a master key created on the fly by the operating system driver, and the server's communication Public key.

The operating system driver sealing involves two calls to the bios layer. The first one is for the MKContainer using OsdMKContainerSeal( ) then the BIOSRawRSAPublic( ) to encrypt the MK that was just used in the MKContainer seal operation. The steps required to seal this container are as follows. These steps operate on the buffer in-place and thus overwrite the unsealed plaintext data. The Usage values will be different for containers sealed by the client and server as explained in the section on usage values.

Confirm that the selected public key is known to SMI routine. If not return error. Confirm the Length is acceptable. Before sealing, this is the length of the first part and the unsealed second part. After sealing, it includes the extra data added by sealing the second part. Confirm that Format equals FmtPubKcontainer. Seal the second part using the MK passed by the operating system driver security module and the steps described regarding the MKContainer.

The master key will be randomly generated by the operating system driver when the PubKContainer is first made. A handle on this master key is returned to the operating system driver's caller so it may be reused. Increment the Length field to include the Mac and Padding added by the previous step. Set PublicKeyDigest to SHA1 digest of the selected public key. Set the Opcode and Format portion of the PubKRSABlock to match the header values. The rest of the block is filled in by the OSD routines before these steps are performed. Perform OAEP padding of the PubKRSABlock using a random OAEP seed value chosen by the operating system driver module. Call BIOSRawRSAPublic to perform the RSA operation with the selected key. After the operating system driver has sealed the PubKContainer structure it has the format shown in Table 11.

Unsealing a PubKContainer will now be discussed. In the disclosed embodiments of the present invention, the Device Authority server performs unsealing. The reply from the server will be in the form of an MK container. The client will unseal the server response using the MK container operations.

The steps required to unseal the PubKContainer on the server are as follows. Errors zero the container.

Confirm the Length is acceptable. This is the length of the first and second part including the sealed MKContainer. Confirm that Format equals FmtPubcontainer. Confirm that PublicKeyDigest corresponds public key that matches the selected private key. Perform a raw RSA decryption operation on PubKRSABlock with the selected private key. Remove the OAEP padding and confirm the OAEP redundancy is correct (i.e., that the block was not modified in transit). This leaves the Opcode, Format, KID and K visible to the caller. Confirm that the Format is FmtPubKContainer. The caller will check whether the Opcode is acceptable. Let Key be the MK from the decrypted PubKRSABlock. Unseal the MKContainer using Key and the steps described regarding the MKContainer.

24. Cryptographic Primitives and Common Values

Deriving keys include AppKey( ), NewKey( ), and CustomerAppKey( ) which may all be the same function:

XxxKey(bufferOf128bits,bufferOf160bitsWithTheHighOrderBitsZeroedIf DataWasLessThan160bits).

AppKey (Key, CodeDigest)=TruncateTo128bits(SHA-1(Key∥CodeDigest))

The keys for protecting AppContainers are derived from the DMK using a 160-bit digest of the code for the program that owns this container. The resulting key is 128-bits long (128 bits is common and sufficient for many encryption algorithms). The reason for hashing the Key∥CodeDigest is to allow a non-Root Device Authority server to create their own AppContainers without letting them know what the actual master key is. Knowing the actual DMK compromises all other AppContainers.

New Key (Key, Usage)=TruncateTo128bits(SHA-1(Key∥Usage)), where the Usage parameter is a 32-bit value. Hashing and truncating is used to simplify the code because in the NewKey( ) case there is no need to expose the resulting key. Also NewKey( ) sometimes takes AppKey( )'s result as an argument.

CustomerAppKey (Key, CustomerSecret)=TruncateTo128bits(SHA-1(Key∥CustomerSecret)), where the CustomerSecret is a 128-bit value. This function is used the generate keys for AppContainers that include a CustomerSecret portion.

AppCodeDigest=Enc160Bits (DMK, DecryptedCodeDigest) and DecryptedCodeDigest=Dec160Bits (DMK, AppcodeDigest) are used to encrypt and decrypt a 160-bit digest value using the DMK and are a crucial part of the mechanism that requires the Device Authority server to be involved in creating the first AppContainer for a specific program on a specific device. The server performs the Enc160Bits function and client machines perform the Dec160Bits function.

The Enc160Bits function performs the following steps. Copy DecryptedCodeDigest into the AppCodeDigest buffer. Let Key=NewKey (DMK, UsageAppCodeDigest). Let Plaintext1=First 16 bytes of AppCodeDigest. This is the first 16 bytes of DecryptedCodeDigest. Let Ciphertext1=RC6CBCEncrypt (Key, Plaintext1). This is equivalent to ECB mode since the plaintext is only one block long.

Replace the first 16 bytes of AppCodeDigest with Ciphertext1. Let Plaintext2=Last 16 bytes of AppCodeDigest. The first 12 bytes of this value are the last 12 bytes of Ciphertext1 and the last 4 bytes of this value are the last 4 bytes of DecryptedCodeDigest. Let Ciphertext2=RC6CBCEncrypt (Key, Plaintext2). This is equivalent to ECB mode since the plaintext is only one block long. Replace the last 16 bytes of AppCodeDigest with Ciphertext2.

The Dec160Bits function performs the following steps. Copy AppCodeDigest into the DecryptedCodeDigest buffer. Let Key=NewKey (DMK, UsageAppCodeDigest). Let Ciphertext2=Last 16 bytes of DecryptedCodeDigest. This is the last 16 bytes of AppCodeDigest. Let Plaintext2=RC6CBCDecrypt (Key, Ciphertext2). This is equivalent to ECB mode since the ciphertext is only one block long. Replace the last 16 bytes of DecryptedCodeDigest with Plaintext2. The last 4 bytes of DecryptedCodeDigest now have their correct value. Let Ciphertext1=First 16 bytes of DecryptedCodeDigest. This includes the first 4 bytes of AppCodeDigest and the first 12 bytes from Plaintext2. Let Plaintext1=RC6CBCDecrypt (Key, Ciphertext1). This is equivalent to ECB mode since the ciphertext is only one block long. Replace the first 16 bytes of DecryptedCodeDigest with Plaintext1.

Enc (Key, Usage, Message)=RC6CBCEncrypt (NewKey(Key, Usage), Message)

Dec (Key, Usage, Message)=RC6CBCDecrypt (NewKey(Key, Usage), Message), where the initialization vector for cipher block chaining (CBC) mode is 16-bytes of zeros, and the Usage value is 32-bits long. Cipher block chaining is a block cipher mode that combines the previous block of ciphertext with the current block of plaintext before encrypting it. The Key will be either 128-bits or 288-bits long. The Message parameter specifies a block of data that is a multiple of 16 bytes long. The RC6 cipher is defined in “The RC6TM Block Cipher” by Ronald L. Rivest, M. J. B. Robshaw, R. Sidney and Y. L. Yin. Aug. 20, 1998, and CBC mode is defined in “Applied Cryptography Second Edition” by Bruce Schneier, John Wiley & Sons, New York, N.Y. 1995.

RC6 was designed to specifically meet the requirements of the NIST AES (Advanced Encryption Standard). RC6 includes support for variable length key sizes and was optimized to take advantage of advances in CPUs since RC5.

When this primitive is used with most containers, the Message begins with a 16-byte random value (called the IV) and is padded at the end with one to 16 bytes to make the Message a multiple of the block size of the cipher (16-bytes). Notice that the 16-byte IV is not used as in traditional CBC mode, since it is not directly XORed with the following plaintext block. Instead, during encryption, it is XORed with zeros (which does nothing) and then encrypted with the key to produce the first block of ciphertext. The first ciphertext block is then XORed with the next plaintext block before encrypting that block. During decryption the first block is decrypted and XORed with zeros (which does nothing) to produce the original random IV block. The second ciphertext block is decrypted and XORed with the first block of ciphertext to produce the second block of plaintext.

The padding for Enc and Dec is a series of identical bytes whose value equals the number of bytes of padded. For example, if two bytes of padding are added, each byte will have the value 0×02. There is always at least one byte of padding, so if the plaintext is already a multiple of 16 bytes long, then 16 bytes of padding are added and each of those bytes will have the value 0×10. Religious wars are fought over the virtues of random versus predictable padding bytes. This design calls for predictable padding bytes. Notice that it is easy to determine how much padding was added by examining the last byte of the decrypted data.

HMAC(Key,Message) primitive. The basic integrity primitive is called HMAC, which is a hash-based message authentication code defined in Internet Engineering Task Force RFC 2104: “HMAC: Keyed-Hashing for Message Authentication” by H. Krawczyk, M. Bellare and R. Canetti. HMAC can be based on any cryptographic hash (digest) function. In the present invention it is based on SHA-1, which is defined in “Secure Hash Standard” by the U.S. National Institute of Standards and Technology in FIPS 180-1, Apr. 17, 1995. Papers published on the HMAC primitive show that it has excellent security properties that make up for potential weaknesses in the digest function. SHA-1 is a secure hash algorithm for computing the condensed representation of a message or data file. When a message of any length<2 64 bits is input, the SHA-1 produces a 160-bit output called a message digest. The message digest can then be input to the Digital Signature Algorithm (DSA) that generates or verifies the signature for the message.

HMAC (Key, Message)=SHA-1 (Key XOR Opad∥SHA-1 (Key XOR Ipad∥Message))

The Opad and Ipad values are different constants that are 512-bits long to match the block size of SHA-1's internal compression function. The Key must be less than 512-bits long in this design. The Opad and Ipad values and the other details of HMAC are defined in RFC 2104. The HMAC primitive requires two more iterations of the SHA1 compression function as compared with a straight digest of the message. This is a low overhead to pay for excellent security properties.

HMAC is a mechanism for message authentication using cryptographic hash functions. HMAC can be used with any iterative cryptographic hash function, e.g., MD5, SHA-1, in combination with a secret shared key. The cryptographic strength of HMAC depends on the properties of the underlying hash function.

The RSA operations are performed in the BIOS.

Ciphertext=RSAOaepEncrypt (PublicKey, OaepSeed, Message)

Message=RSAOaepDecrypt (PrivateKey, Ciphertext)

These primitives perform encryption and decryption using the RSA algorithm. For the encrypting primitive, the Message is first padded using OAEP (optimal asymmetric encryption padding) as defined in “PKCS #1 v2.0: RSA Cryptography Standard” by RSA Laboratories, and then exponentiated and mod-reduced according to the PublicKey. The random seed value required by OAEP is passed in as a parameter to this function. For the decrypt primitive, the OAEP padding is verified and removed after the ciphertext is exponentiated and mod-reduced according to the PrivateKey. In most cases the Message is the concatenation of a 128-bit key and 160-bit DMK KID.

The PKCS are designed for binary and ASCII data; PKCS are also compatible with the ITU-T X.509 standard. The published standards are PKCS #1, #3, #5, #7, #8, #9, #10 #11 and #12; PCKS #13 and #14 are PKCS includes both algorithm-specific and algorithm-independent implementation standards. Many algorithms are supported, including RSA (and Diffie-Hellman key exchange, however, only the latter two are specifically detailed. PKCS also defines an algorithm-independent syntax for digital signatures, digital envelopes, and extended certificates; this enables someone implementing any cryptographic algorithm whatsoever to conform to a standard syntax, and thus achieve interoperability. Documents detailing the PKCS standards can be obtained at RSA Data Security's FTP server (accessible from http://www.rsa.com or via anonymous ftp to ftp.rsa.com or by sending e-mail to pkcs@rsa.com).

The following are the Public-key cryptography Standards (PKCS):

PKCS #1 defines mechanisms for encrypting and signing data using RSA public-key cryptosystem.

PKCS #3 defines a Diffie-Hellman key agreement protocol.

PKCS #5 describes a method for encrypting a string with a secret key derived from a password.

PKCS #6 is being phased out in favor of version 3 of X.509.

PKCS #7 defines a general syntax for messages that include cryptographic enhancements such as digital signatures and encryption.

PKCS #8 describes a format for private key information. This information includes a private key for some public key algorithm, and optionally a set of attributes.

PKCS #9 defines selected attribute types for use in the other PKCS standards.

PKCS #10 describes syntax for certification requests.

PKCS #11 defines a technology-independent programming interface, called Cryptoki, for cryptographic devices such as smart cards and PCMCIA cards.

PKCS #12 specifies a portable format for storing or transporting a user's private keys, certificates, miscellaneous secrets, etc.

PKCS #13 defines mechanisms for encrypting and signing data using Elliptic Curve Cryptography.

PKCS #14 gives a standard for pseudo-random number generation.

SigBlock=RSASigEncrypt (PrivateKey, Digest) and Digest=RSASigDecrypt (PublicKey, SigBlock) primitives perform encryption and decryption using the RSA algorithm. For the encrypt primitive, the 160-bit SHA-1 digest value is first padded using signature padding as defined in “PKCS #1 v2.0: RSA Cryptography Standard” and then exponentiated and mod-reduced according to the PublicKey. For the decrypt primitive, the padding is verified and removed after the ciphertext is exponentiated and mod-reduced according to the PrivateKey. The padding encodes the identity of the digest algorithm and these primitives only support the SHA1 algorithm. These primitives are part of the process to create and verify digital signatures. The other steps involve computing or verifying the actual SHA1 digest of the data being signed.

The AppCodeDigest is data that is used to identify the application that owns a container. It does not apply to all containers. This data is generated based on the code that is invoking cryptographic functions. This data is normally generated, encrypted and signed by the Device Authority. Most of the time the decrypted AppCodeDigest (ACD) is compared against the CallerCodeDigest at runtime by the BIOS. A CodeDigest that belongs to the server are always zero.

The SealerCodeDigest/CallerCodeDigest is data calculated in functions based on the caller of the function. The information used to calculate this digest is provided during registration such as registration with the BIOS, and registration with the operating system driver, in a SingedContainer with OpaacOsdAuthorization as the container opcode.

Enrollment is an early stage a client system goes through. During this stage the master key is created and exchanged between the client system and the Device Authority server. This step involves PubKContainers. When the enrollment process has not yet assigned the master key, the master key is replaced with a temporary random value until the true master key replaces it.

Both the BIOS and the operating system driver (OSD) participate in container operations. Container functions relating to seal include OSDAppContainerSeal( ), OSDMKContainerSeal( ),OSDPubKContainerSeal( ), and BIOSAppContainerSeal( ).

The OSDPubKContainerSeal( ) function creates a random session key (Master Key) that it returns to the caller inside an AppContainer. The AppContainer is then used to invoke other MKContaner( ) operations. FIG. _______ illustrates an exemplary PubKContaner algorithm

Container functions relating to unseal include OSDAppContainerUnseal( ), OSDMKContainerUnseal( ), OSDSignedContainerUnseal( ), OSDPubKContainerUnseal( ), and BIOSAppContainerUnseal( )

25. Container Classes Implementation Details

These classes include PubkContainer and MKContainer.

The following is a description of the format of a PubKContainer and methods in the class used in sealing and unsealing. These containers are primarily used to set up a secure communication channel between the client and the Device Authority server. The second part of the PubKContainer is a complete MKContainer object including the 4-byte header. The first part of the PubKContainer includes the value of the generated master key (MK) and the client's Key ID (KID), (or zeros if the master key has not been assigned), and both values are encrypted with the recipient's public key.

The format of the PubKContainer is carefully chosen to allow changing the second part of this container without changing the first part. This allows the client and server to implement some significant performance improvements. The OSD sealing function will return the generated Master Key wrapped in an AppContainer. The client could store and reuse the Master Key and the first part of the PubKContainer each time it starts a new connection to the server (e.g., to fetch a new download) and the second part will be an MKContainer that contains a new Master Key for encrypting this session. This avoids the need to perform a public key operation with the SMI routines and yet gets the security benefits of knowing that only the real server will know the new session key, since only the real server knows the saved Master Key (needed to decrypt the new session key) or knows the private key to read the first part. The important optimization for the server is to cache the Master Key that it extracts out of the first part of the PubKContainer and to index that cached value by the hash of the first part. This cache avoids the need to perform a private key operation when the first part of the PubKContainer is reused. Notice that the server can flush cache entries at any time because the client always sends the whole first part and thus the server can always use its private key to extract the Master Key. This also means that there is only one format for the initialize message between the client and server, not two separate formats to handle either reusing or creating an Master Key.

The PubkContainer is used to setup transmissions between the client and a server during enrollment to allow setting up of the DMK, and setup transmissions between some client applications and a Device Authority server. Table 11 illustrates the final sealed PubKContainer structure.

Constructors and methods relating to the PubkContainer are as follows.

public PubkContainer( ) is an empty container which initializes the logger object. As for the public PubkContainer(InputStream in), the container is initialized with the input stream which is then read into a buffer as an array of bytes. The buffer is then parsed using parseBuffer method. A logger object is also initialized.

public PubkContainer(byte [ ] buf).

The container is initialized byte array which is then read into a buffer as an array of bytes. The buffer is then parsed using a parseBuffer method. A logger object is also initialized. The private void seal( ) throws RsaLibException. The following are set to seal a PubKContainer: opcode , KID , MK,PubkDigest, Sealed MKContainer. Set Format to 3=FmtPubKContainer. Build PubkBlock with opcode,format,reserved ,KID and MK. Opcode, KID and master key are set by the caller. Call JNI wrapper for RSA lib in a try block, rsaOaepEncrypt(PubKDigest,PubKBlock) to build encrypted PubKRSABlock. Set length as length of sealed MKContainer(MkC)+148 (128-PubKRSABlock,20-PubKDigest). This length represents count of bytes from PubKDigest including the sealed MkContainer. Build sealed PubkContainer as byte array as

Opcode∥format∥reserved∥length∥PubkDigest∥PubKRSABlock∥sealedMkC.

Use addArray method from security utilities class to build concatenated arrays.

private void unseal( ) throws RsaLibException, ContainerException.

Checks if invalidOpcode,invalidFormat or invalidLen are false and throws a ContainerException. These are set to false in parseBuffer if any of them is not as expected.

Get PubKBlock which is opcode∥format∥reserved∥KID∥MK, by deciphering.

PubKRSABlock with rsaOaepDecrypt(PubKDigest,PubKRSABlock) via JNI wrapper for RSA lib.

Perform validity and length checks on PubKBlock, opcode, format, KID and master key.

private void parseBuffer(byte[ ] buffer) is a helper function to parse incoming sealed container stored in a buffer which is, opcode∥format∥reserved∥length∥PubKDigest∥PubKRSABlock∥Sealed MKC.

Set invalidOpcode, invalidFormat, invalidLen if not as expected.

public byte[ ] getRawForNet( )throws ContainerException

Checks that data and MKDigest are not null and then calls seal method

Returns buffer which is built in the seal operation as

opcode∥format∥reserved∥length∥PubKDigest∥PubKRSABlock∥Sealed MKC.

public byte getOpcode( )returns opcode of the container.

public byte[ ] getPubKDigest( )returns PubKDigest from the container.

public byte[ ] getKID( )returns KID from the container, unsealing if necessary

public byte[ ] getMK( ) throws ContainerException

returns MK from the container, unsealing if necessary.

public MkContainer getMkContainer( ) throws ContainerException—extracts sealed MK container embedded in Pubk which is done by parseBuffer; unseals the Pubk part to get MK and set it for the MK container.

public void setOpcode(byte Opcode) throws ContainerException—assigns opcode for the container after checking if it is in valid range.

public void setPubKDigest(byte[ ] digest) throws ContainerException—throws exception if null is passed or length not equal to 20,sets PubKDigest.

public void setKID(byte[ ] Kid) throws ContainerException—throws exception if null is passed or length not equal to 20,sets Key ID.

public void setMK(byte[ ] Mk) throws ContainerException—throws exception if null is passed or length not equal to 16,sets MK.

public void setMKContainer(byte[ ] Mkc) throws ContainerException—sets the sealed MkContainer to be embedded in the PubKContainer.

private void log(int aWarningLevel, String message)—compares the warning level passed as a parameter with the current one, and outputs it if it is more urgent.

Constructors and methods relating to the MKContainer are as follows.

public MkContainer( ) is an empty container which just initializes the logger object.

public MkContainer(InputStream in)—the container is initialized with input stream which is then read into Buffer an array of bytes ,buffer is then parsed using parseBuffer method. A logger object is also initialized.

public MkContainer(byte [ ] buf)—the container is initialized byte array which is then read into Buffer an array of bytes ,buffer is then parsed using parseBuffer method. A logger object is also initialized.

private void seal( ) throws RsaLibException

The following are set to seal a MKContainer, call set methods on these opcode, MKDigest,data

Set Format to 3 equals FmtPubKContainer.

Set scd as 20 byte array of Zero's

Construct length as data length+56 (20-MKDigest+16-iv+20-scd)

Convert length into a 2 byte array

Get iv as 16 byte array from random number generator ,call cryptoPrimitives generateRandomNumber(16) method

Build payload using addToArray method of security utilities as

opcode∥format∥reserved∥length∥MKDigest∥iv∥scd∥data.

Construct newKey as NKeyForSealing=CryptoPrimitive.newKey(MKDigest,ctnrConstants.UsageMKMacServer);

Mac is then obtained from cryptoPrimitive call as

Mac=CryptoPrimitive.getHmac(NKeyForSealing,payload);

Build Plaintext as iv∥scd∥data∥mac

Set Padding to a vector of 1 to 16 bytes to make the variable, Plaintext, (see below) be a multiple of 16 bytes long. Each padding byte has a value equal to the number of padding bytes in the vector. This is done using adjustPad method in SecurityUtils class.

Add padding to Plaintext now Plaintext is

iv∥SealersCodeDigest∥Data∥Mac∥Padding.

Let Ciphertext=Enc (Key, UsageMKEnc, Plaintext). The length of Ciphertext will be the same as Plaintext.

Set Length to the number of bytes in Plaintext plus 20 (for MKDigest) ,store the value in a 2 byte array.

Construct a sealed MkContainer as a buffer with

opcode∥format∥reserved∥length∥MKDigest∥ciphertext

private void unseal( ) throws RsaLibException, ContainerException. Check if invalidOpcode, invalidFormat or invalidLen are false and throws a ContainerException. These are set to false in parseBuffer if any of them is not as expected. Ciphertext that is extracted from parseBuffer is passed to CryptoPrimitive ,decrypt method to get the deciphered plaintext. dec method is called as dec(MKDigest,ctnrConstants. UsageMKEncServer,ciphertext).

From the last byte of plaintext the pad byte is know and as it gives how many pad bytes have been added.pad bytes are removed from the plaintext ,data size is calculated by removing the mac length and no. of pad bytes from length of plaintext.

Length of iv,scd and data is calculated and stored in a 2 byte array. Since the length of data is calculated and length of iv,scd and mac are predetermined, all these are extracted from the plaintext.

Modify Length=Length minus 20 minus length-of-Padding.

Build payload as Opcode∥Format∥reserved∥length∥MKDigest∥iv∥scd∥data. Construct newKey as NKeyForSealing=

CryptoPrimitive.newKey(MKDigest,ctnrConstants.UsageMKMacServer);

ExpectedMac is then obtained from cryptoPrimitive call as

expectedMac=CryptoPrimitive.getHmac(NKeyForSealing,payload);

Throw ContainerException if mac and expectedMac are not equal.

private void parseBuffer(byte[ ] buffer) is a helper function to parse incoming sealed container stored in a buffer which is

opcode∥format∥reserved∥length∥MKDigest∥cipheredText

ciphered text consists of ∥IV∥SealersCodeDigest∥Data in an encrypted form.

set invalidOpcode,invalidFormat,invalidLen if not as expected.

public byte[ ] getRawForNet( )throws ContainerException checks that Key ID,MK and sealed MkC (MkBuff) are not null and then calls seal method. It returns buffer which is built in the seal operation as

Opcode∥Format∥Length∥MKDigest∥IV∥SealersCodeDigest∥Data∥mac∥pad.

public byte getOpcode( )—returns opcode of the container.

public byte[ ] getMKDigest( )throw ContainerException—returns MKDigest from the container.

public byte[ ] getData( ) throws ContainerException—returns data from the container, unsealing if necessary.

public byte[ ] getMK( ) throws ContainerException—returns MK from the container.

public void setOpcode(byte Opcode) throws ContainerException—assigns opcode for the container after checking if it is in valid range

public void setMKDigest(byte[ ] digest) throws ContainerException—throws exception if null is passed or length not equal to 20,sets MKDigest

public void setData(byte[ ] Kid) throws ContainerException—throws exception if null is passed ,sets data

public void setMK(byte[ ] Mk) throws ContainerException—throws exception if null is passed or length not equal to 16,sets MK

private void log(int aWarningLevel, String message)—compares the warning level passed as a parameter with the current one, and outputs it if it is more urgent.

26. OSD Software

The operating system driver (OSD) is one of the core components of the system 10. It is a kernel mode driver that is dynamically loaded into the system. Its upper edge provides the security services to the security application. Its lower edge interfaces with the security BIOS that provides the low-level security functionalities. The services the operating system driver provides include RSA and RC6 cryptographic functions, application integrity checking and random number generating.

The software operating environment employs an operating system driver such as a WDM Windows device driver. The device driver also runs under Windows 98, Windows ME, Windows 2000 and future Microsoft Windows operating systems.

The following is a detailed description of the operating system driver (OSD) functionalities. The operating system driver is a WDM kernel mode driver that can runs under Windows 98, Windows ME and Windows 2000. WDM is based on a Windows NT-layered 32-bit device driver model, with additional support for PNP and Power Management. Because the operating system driver doesn't manage any physical device, no hardware resource will be allocated. The operating system driver is implemented as one module. There is no class/mini class driver pair. When the operating system driver is loaded into the system, a Functional Device Object (FDO) is created. FIG. 3 illustrates operating system driver component interaction

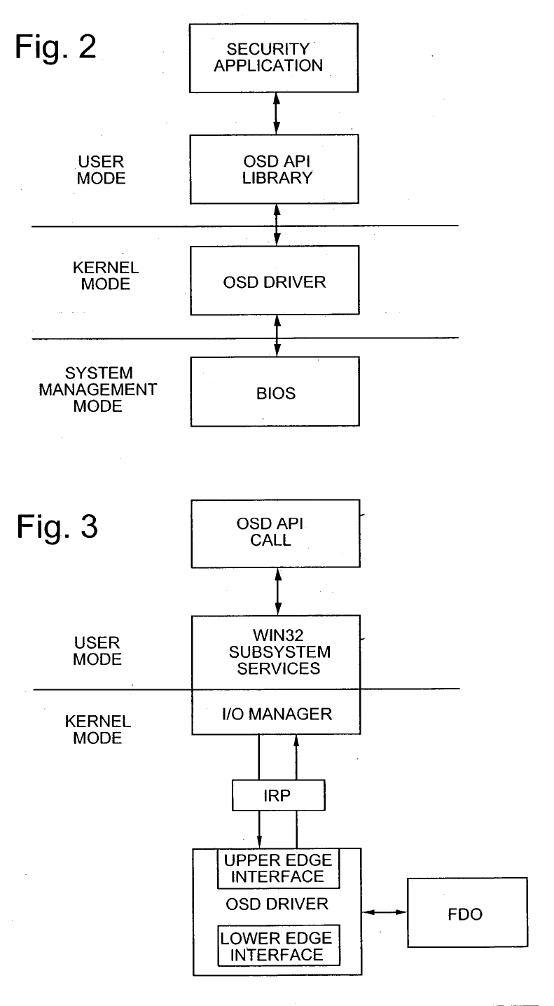

Theory of operation will now be discussed and will outline the procedures of the OSD operations. FIG. 2 illustrates a client component hierarchy

26.1. OSD Initialization

Before an application calls the OSD functions, it registers itself with the operating system driver by calling OsdRegisterApplication function. The operating system driver does the following to register an application. Get the application identification information, such as Process ID.

Get the public key index based on the key digest in the SignedContainer that is passed in as parameter. The key table the operating system driver creates during initialization maps the key digest to the key index. Call BIOSRawRSAPublic routine to unseal the data block in the SignedContaner. The data block contains address range, expected code digest and PrivilegeBitVector and the frequency of the integrity checking.

Create the code digest of the portion of the calling application based on the address range. The application should be so implemented that all the OSD function invocations are close together, referred to as an OSD Service Invocation Block (SIB). The OSD Service Invocation Block must (legally required) be non-generic so as to prevent other application from jumping into the SIB and use the OSD's API for its own purpose. This SIB is a set of value added APIs that are specific to the calling application.

Compare the created code digest and the expected code digest. If they are the same the application is authorized otherwise return error. If the application is authorized, add an entry in the registered application table. The entry contains the application's identification information (Process ID), address range of the OSD Service Invocation Block, the code digest of the OSD Service Invocation Block and PrivilegeBitVector and the integrity checking frequency.

26.2. OSD Service Invocation

An application can request the OSD services after it registers with the operating system driver. The operating system driver does the following each time its function is invoked

Check the application's integrity. Based on the integrity checking frequency from the registered application table. The operating system driver does it by creating the code digest of the application's OSD Service Invocation Block. Then compared with the expected code digest. The application integrity is OK if they are the same. Otherwise return error.

Check the Privilege Bit Vector to see if the application has the authority to call this function in particular. Continue to execute the OSD code to serve the request. The operating system driver may call the security BIOS routines depending on the requested service. Call OsdRandomAddNoise function. This will increase the unpredictability of the PRNG.

26.3. Application Unregistration.

Before an application terminates gracefully, it calls OsdUnregisterApplication to unregister itself with the operating system driver. The OSD driver removes the application's entry in the registered application table.

Registered application table creation will now be discussed. The operating system driver maintain a table of registered applications. Based on the application's checking frequency from the registered application table, the operating system driver periodically check the caller's integrity. It gets the address range of the caller's OSD Service Invocation Block and creates the code digest. Then check again the expected code digest from the registered application table.

RSA cryptographic functionality will now be discussed. The operating system driver implements the interface functions to do the PubKcontainer sealing (but not for enrollment where the PubKContainer is created in the BIOS, AppContainer sealing/unsealing and SignedContainer unsealing. However, all the RSA public/private key algorithms are implemented in the security BIOS. The operating system driver calls the BIOS routine to complete the container operations.

The operating system driver implements the RC6 algorithm functions to seal/unseal MKContainer. This is done in the operating system driver itself instead of in the BIOS except during enrollment where the BIOS does the MKContainer handling to protect the master key

26.4. OSD Interfaces and APIs

This section describes the operating system driver's interface with the system kernel and interface with the security BIOS. This section also defines the OSD API functions that the user-mode applications can call to get OSD security services. Also described here are the internal functions the operating system driver should implement.

The upper edge interface of the operating system driver functions as follows. Under the WDM model, the system I/O manager makes an I/O request to a device driver by creating an I/O Request Packet (IRP) and sending it down to the device driver. OSD security services can be invoked by sending DEVICE_IO_CONTROL IRP. Each handler routine for a Device_IO_Control code provides a specific function. The operating system driver IO_CONTROL codes are defined in the following.

IOCTL_OSD_REGISTER_APPLICATION. The handler routine registers the application with the operating system driver and calls BIOS routines.

IOCTL_OSD_UNREGISTER_APPLICATION. The handler routine unregisters the application with the operating system driver.

IOCTL_OSD_GET_PUBLIC_KEY. The handler routine fetches the public key from the BIOS using the key index as parameter and calls BIOS routines.

IOCTL_OSD_VERIFY_SIGNED_DIGEST. The handler routine verifies the RAS digital signature of a data block. Need to call BIOS routine.

IOCTL_OSD_RANDOM_GENERATE. The handler uses PRNG to generate a random number. This handler may or may not call BIOS routine depending on the PRNG implementation.

IOCTL_OSD_PUBK_CONTAINER_SEAL. The handler encrypts a block of data in a container using the public key specified with key index and calls BIOS routines

IOCTL_OSD_SIGNED_CONTAINER_UNSEAL. The handler routine verifies if a container is really signed by an authorized server and calls BIOS routines

IOCTL_OSD_APP_CONTAINER_SEAL. The handler routine seals an AppContainer with a key derived from the master key and calls BIOS routines

IOCTL_OSD_APP_CONTAINER_UNSEAL. The handler routine unseals an AppContainer with a key derived from the master key and calls BIOS routines

IOCTL_OSD_APP_CONTAINER_TRANSFER. The handler routine seals an AppContainer that only can be unsealed by another program running on the same platform or different platform. Calls BIOS routine to unseal the SignedContainer that contains the authorization information.

IOCTL_OSD_MK_CONTAINER_SEAL. The handler routine seals a container with a master key. The actual sealing is done inside the operating system driver. Calls BIOS routine to unseal the AppContainer to get the master key.

IOCTL_OSD_MK_CONTAINER_UNSEAL. The handler routine unseals a container with a master key. The unsealing is done inside the operating system driver. The BIOS routine is called to the AppContainer to get the master key.

IOCTL_OSD_ENROLL_GENERATE_REQUEST. The handler routine calls BIOS routines to generate pseudo DMK, message key and DMK client seed.

IOCTL_OSD_ENROLL_PROCESS_RESPONSE. The handler routine call BIOS routine to generate the master key for this platform.

IOCTL_OSD_INVALIDATE_DMK. The handler routine calls a BIOS function to invalidate the master key generated by previous enrollment.

IOCTL_OSD_SET_PUBLIC_KEY. The handler functions installs extra RSA public key in the BIOS key table.

The low edge interface of the operating system driver will now be discussed. On the low edge interface of the operating system driver, the operating system driver calls the security BIOS interface routines to get security services provided by the low level BIOS. The security BIOS interface will be implemented based on 32-bit Directory Service interface. The function index should be defined for all the services that the security BIOS provides. When the operating system driver is loaded into the system, it needs to search the Security BIOS entry point. Before each routine call, the operating system driver need to set up the register context based on the security BIOS specification.

27. User Mode API Functions

A User Mode API library is implemented. A security application can access the security services the operating system driver provides by calling the functions in this library. The API functions are described below.

int OsdRegisterApplication (IN unsigned char *pAuhorizationBuffer, IN unsigned int *pAuthorizationBufferLength)

This function registers an application with the OSD code. It verifies the application has been authorized and save the application information in the registered application table the OSD maintains. The other OSD calls will only work if they are called from a location within a registered application or from another OSD function. It returns zero if the registration is successfully. Otherwise it returns an error. The pAuhorizationBuffer and pAuthorizationBufferLength parameters specify the location and length of a SignedContainer that was created by the Device Authority server.

This function uses IOCTL_OSD_REGISTER_APPLICATION to invoke OSD service.

int OsdGetCapabilities(OUT unsigned short *pVersion, OUT unsigned short *pCapabilities)

This function returns the OSD version number and the OSD CR capabilities and system status.

The version number is defined as follows:

First byte Second byte

Minor version Major version

The Capabilities WORD is defined are as having 15 bits. Bit 0 indicates the system has already enrolled successfully. 1, succeeded. 0, failed, bit 1 indicates the enrollment type. 0, offline enrollment; 1, online enrollment, and bits 2-15 are reserved.

This function uses IOCTL_OSD_GET_CAPABILITIES to invoke OSD service.

The int OsdUnregisterApplication ( ) function unregitsers the caller by removing the caller's entry from the registered application table. This function uses IOCTL_OSD_UNREGISTER_APPLICATION to invoke OSD service.

int OsdGetPublicKey (IN int nKeyIndex, OUT unsigned char *pModulusBuffer, IN/OUT unsigned int *pModulusBufferLength, OUT unsigned int *pExponent)

This function returns zero if it succeeds in fetching the RSA public key that is located in the nKeyIndex row of the key table. The modulus of the public key (a 1024-bit number) is returned in the specified buffer, and the exponent of the public key (either 3 or 65537) is placed in the location identified by pExponent. The location identified by pModulusBufferLength is initially set to the maximum length of pModulusBuffer in bytes, and after the call returns it is set to the number of bytes actually used. A non-zero return value indicates an error. The key's modulus is copied into the buffer with the Most Significant Byte (MSB) first. The nKeyIndex values start at zero and increase sequentially for keys that are loaded from flash ROM. Negative nKeyIndex values to refer to keys that are loaded into the SMRAM public key table by the OSD Security Module after the OS is running.

This routine can be used by an application to locate the nKeyIndex that corresponds to the public key that the application knows about from an X.509 certificate

This function returns an error if the caller is not a registered application or another OSD routine. Periodically, this function will verify that the SHA1 digest of the caller's code has not changed since it was registered.

This functions uses IOCTL_OSD_GET_PUBLIC_KEY to invoke the OSD service.

int OsdRSAVerifySignedDigest (IN int nKeyIndex, IN unsigned char *pSignedDigestBuffer, IN unsigned int *pSignedDigestBufferLength, IN unsigned char *pDigestBuffer,IN unsigned int *pDigestBufferLength)

This function verifies an RSA digital signature. It performs a PKCS #1 formatted RSA public key operation to decrypt the data buffer specified by pSignedDigestBuffer and pSignedDigestBufferLength using the public key specified by nKeyIndex to extract the expected digest value that was encrypted using the matching private key. It compares the expected digest to the value specified by the pDigestBuffer and pDigestBufferLength parameters. If they are equal, it returns zero, otherwise it returns a non-zero error code. The routine will also return an error if the nKeyIndex is invalid. The pDigestBuffer and pDigestBufferLength values could result from calling the OsdSHA1Final routine.

The data in pSignedDigestBuffer is stored MSB first and it must be exactly as long as the modulus for the selected public key.

This function returns an error if the caller is not a registered application or another OSD routine. Periodically, this function will verify that the SHA1 digest of the caller's code has not changed since it was registered.

This function uses IOCTL_OSD_VERIFY_SIGNED_DIGEST to invoke the OSD service.

int OsdDigestInit (OUT DigestContext *pDigestContext)

This function can be called by any application. It initializes a data structure in the caller's address space that will be used to compute SHA1 digest values.

The caller can modify this data structure, so the OSD module cannot rely on the correctness of the results. When these SHA1 routines are used by an application to verify signatures, the application is trusting itself to compute the correct digest value and then trusting the operating system driver (and in turn the BIOS SMI security module) to compute with the correct RSA public key. When the OSD layer is registering a new application, the data structure is kept within the operating system driver's memory, so the operating system driver can trust the result. See section 8 for the DigestContext data structure definition.

int OsdDigestUpdate (IN DigestContext *pDigestContext, IN unsigned char *pBuffer, IN unsigned int *pBufferLength)

This function can be called by any application. It uses a data structure in the caller's address space to update the state of a SHA1 digest object by feeding it the data byte specified by the pBuffer and pBufferLength parameters.

The pBufferLength is a pointer to a location that must be filled in with a count of the number of bytes in the buffer before calling this routine. This routine does not change that location, so the length could be passed directly instead of by reference. However, all buffer length values in this design are passed by reference in order to make the interfaces more uniform.

int OsdDigestFinal (IN DigestContext *pDigestContext, OUT unsigned char *pDigestBuffer, IN/OUT unsigned int *pDigestBufferLength)

This function can be called by any application. It uses a data structure in the caller's address space to compute the final result of a SHA1 digest of a block of data that may be passed in zero or more calls to the OsdDigestUpdate routine. It processes the any bytes that remain in the data structure's buffer by appending the padding and total length (in bits) and performing the final digest operation(s). The result is placed in the buffer specified by pDigestBuffer and pDigestBufferLength parameter. Before calling this function, pDigestBufferLength points to a location that specifies the maximum size of the pDigestBuffer, and after successful completion, that location is set to the number of bytes placed in the buffer. For SHA1 digests, the result will be 20-bytes long.

int OsdRandomGenerate (OUT unsigned char *pDataBuffer, IN unsigned int *pDataBufferLength)

This function uses the operating system driver's pseudo random number generator to fill in the specified data buffer with the number of bytes specified by the pDataBufferLength parameter.

If the pDataBufferLength is 20 bytes or less, then the follow steps are performed once and the leading bytes of ResultBlock are copied into the pDataBuffer and the rest are discarded. If more than 20 bytes are needed the following steps are repeated as necessary. The StateBlock and ResultBlock are both 20-byte values. The StateBlock represents the global state of the PRNG.

ResultBlock=SHA1 (StateBlock∥StateBlock)

StateBlock=StateBlock XOR SHA1 (StateBlock∥ResultBlock)

When the pDataBuffer has been filled, end by calling OsdRandomAddNoise ( ).

This function returns an error if the caller is not a registered application or another OSD routine. Periodically, this function will verify that the SHA1 digest of the caller's code has not changed since it was registered.

This function uses IOCTL_OSD_RANDOM_GENERATE to invoke the OSD service.

int OsdPubKContainerSeal (IN int nKeyIndex, IN/OUT unsigned char *pContainerBuffer, IN/OUT unsigned int *pContainerBufferLength, OUT unsigned char *pMKBuffer, IN/OUT unsigned int *pMKBufferLength)

This function is used to ensure that data sent to the Device Authority server cannot be read by other clients. Only the Device Authority server knows the private key necessary to unseal this container. The pContainerBuffer parameter pointers to a block of memory that holds an unsealed PubKContainer structure. The caller should fill in various fields as described in the section on PubKContainers. That section also describes the steps performed by this function. The nKeyIndex identifies the public key that should be used to seal the container.

On input, pContainerBufferLength points to a location that contains the maximum number of bytes that fit in the container buffer. On output, it contains the actual number of bytes used in pContainerBuffer. Information in the pContainerBuffer describes the length of the data that must be protected.

The pMKBuffer and pMKBufferLength parameters specify a buffer that are filled in with an AppContainer that protects the master key that was generated for this PubKContainer. This information is used to create MKContainers with the same master key.

This routine ends by calling OsdRandomAddNoise ( ). This function returns an error if the caller is not a registered application or another OSD routine. Periodically, this function will verify that the SHA1 digest of the caller's code has not changed since it was registered. This function uses IOCTL_OSD_PUBK_CONTAINER_SEAL to invoke the OSD service.

int OsdSignedContainerUnseal (IN/OUT unsigned char *pContainerBuffer, IN/OUT unsigned int *pContainerBufferLength)

This function is used to verify that a container is really signed by a server. It returns an error if the signature is not valid. The format of the SignedContainer and the steps performed by this function are described in the section on SignedContainers.

On input, pContainerBufferLength points to a location that contains the maximum number of bytes that fit in the container buffer. On output, it contains the actual number of bytes used in pContainerBuffer. Information in the pContainerBuffer describes the length of the data that must be protected.

This routine ends by calling OsdRandomAddNoise ( ). This function returns an error if the caller is not a registered application or another OSD routine. Periodically, this function will verify that the SHA1 digest of the caller's code has not changed since it was registered. This function uses IOCTL_OSD_SIGNED_CONTAINER_UNSEAL to invoke the OSD service.

int OsdMKContainerSeal (IN/OUT unsigned char *pContainerBuffer, IN/OUT unsigned int *pContainerBufferLength, IN unsigned char *pMKBuffer, IN unsigned int *pMKBufferLength)

This function is to seal a container so it can only be unsealed by others who know the master key. This key could be either the master key that is known to the device and the server or a new key generated by the client and sent to the server in a PubKContainer. On input, the pContainerBuffer parameter points to a block of memory that holds an unsealed MKContainer structure. On output, the container is sealed. The caller should fill in various fields as described in the section on MKContainers. That section also describes the steps performed by this function. This function uses the client constants for key usage.

On input, pContainerBufferLength points to a location that contains the maximum number of bytes that fit in the container buffer. On output, it contains the actual number of bytes used in pContainerBuffer. Information in the pContainerBuffer describes the length of the data that must be protected.

The pMKBuffer and pMKBufferLength parameters specify a buffer that holds an AppContainer that protects the master key that was generated by a call to the OsdPubKContainerSeal function. This routine ends by calling OsdRandomAddNoise ( ). This function returns an error if the caller is not a registered application or another OSD routine. Periodically, this function will verify that the SHA1 digest of the caller's code has not changed since it was registered. This function uses IOCTL_OSD_MK_CONTAINER_SEAL to invoke the OSD service.

int OsdMKContainerUnseal (IN/OUT unsigned char *pContainerBuffer, IN/OUT unsigned int *pContainerBufferLength, IN unsigned char *pMKBuffer, IN unsigned int *pMKBufferLength, IN int wasSealedByServer)

This function is to unseal a container that was sealed by another entity using the given master key. On input, the pContainerBuffer parameter points to a block of memory that holds a sealed MKContainer structure. On output, the container is unsealed. See the section on MKContainers for the unsealed format. That section also describes the steps performed by this function. The key usage constants used by this routine are the client constants if the parameter, wasSealedByServer, is zero, otherwise they are the server constants. See the section on key usage constants for details.

On input, pContainerBufferLength points to a location that contains the maximum number of bytes that fit in the container buffer. On output, it contains the actual number of bytes used in pContainerBuffer. Information in the pContainerBuffer describes the length of the data that must be protected.

The pMKBuffer and pMKBufferLength parameters specify a buffer that hold an AppContainer that protects the master key that was generated by a call to the OsdPubKContainerSeal function.

This routine ends by calling OsdRandomAddNoise ( ). This function returns an error if the caller is not a registered application or another OSD routine. Periodically, this function will verify that the SHA1 digest of the caller's code has not changed since it was registered. This function uses IOCTL_OSD_MK_CONTAINER_UNSEAL to invoke the OSD service

int OsdAppContainerSeal (IN/OUT unsigned char *pContainerBuffer, IN/OUT unsigned int *pContainerBufferLength)

This function is to seal a container so it can only be unsealed by the same program running on the same device. On input, the pContainerBuffer parameter points to a block of memory that holds an unsealed AppContainer structure. On output, the container is sealed. The caller should fill in various fields as described in the section on AppContainers. That section also describes the steps performed by this function. This function uses the client constants for key usage.

On input, pContainerBufferLength points to a location that contains the maximum number of bytes that fit in the container buffer. On output, it contains the actual number of bytes used in pContainerBuffer. Information in the pContainerBuffer describes the length of the data that must be protected.

This routine ends by calling OsdRandomAddNoise ( ). This function returns an error if the caller is not a registered application or another OSD routine. Periodically, this function will verify that the SHA1 digest of the caller's code has not changed since it was registered. This function uses IOCTL_OSD_APP_CONTAINER_SEAL to invoke the OSD service.

int OsdAppContainerUnseal (IN/OUT unsigned char *pContainerBuffer, IN/OUT unsigned int *pContainerBufferLength, IN int wasSealedByServer)

This function is to unseal a container that was sealed by this application running on this machine or by the server specifically for this application on this machine. On input, the pContainerBuffer parameter points to a block of memory that holds a sealed AppContainer structure. On output, the container is unsealed. See the section on AppContainers for the unsealed format. That section also describes the steps performed by this function. The key usage constants used by this routine are the client constants if the parameter, wasSealedByServer, is zero, otherwise they are the server constants.

On input, pContainerBufferLength points to a location that contains the maximum number of bytes that fit in the container buffer. On output, it contains the actual number of bytes used in pContainerBuffer. Information in the pContainerBuffer describes the length of the data that must be protected. This routine ends by calling OsdRandomAddNoise ( ). This function returns an error if the caller is not a registered application or another OSD routine. Periodically, this function will verify that the SHA1 digest of the caller's code has not changed since it was registered. This function uses IOCTL_OSD_APP_CONTAINER_UNSEAL to invoke the OSD service.

int OsdAppContainerTransfer (IN/OUT unsigned char *pContainerBuffer, IN/OUT unsigned int *pContainerBufferLength, IN unsigned char *pAuhorizationBuffer, IN unsigned int *pAuthorizationBufferLength)

This function is used to seal a container so it can only be unsealed by a different program running on the same device. The original owner of the container looses the ability to open it. Of course, the original owner can make a copy of the contain and continue to open and close that copy, but the transferred container will be encrypted with a different key, so only the new owner can open it. This feature could be used by a secure keyboard reader module to capture keystrokes and securely transfer them to the correct application.

On input, the pContainerBuffer parameter points to a block of memory that holds an unsealed AppContainer structure. On output, the container is sealed. The caller should fill in various fields as described in the section on AppContainers. That section also describes the steps performed by this function. This function uses the client constants for key usage. This function confirms that the caller currently owns the container (checking the DecryptedCodeDigest) before sealing it for use be the new owner.

The pAuhorizationBuffer and pAuthorizationBufferLength parameters specify the location and length of a SignedContainer that was created by the Device Authority server. See the design document for protected containers for details. The opcode is OpcOsdAllowTransfer and the data inside that container specify the AppCodeDigest of the program that is invoking this function and the AppCodeDigest of the program that will be able to unseal this container. The SealersCodeDigest field of the container will identify the program that called this function.

On input, pContainerBufferLength points to a location that contains the maximum number of bytes that fit in the container buffer. On output, it contains the actual number of bytes used in pContainerBuffer. Information in the pContainerBuffer describes the length of the data that must be protected. This routine ends by calling OsdRandomAddNoise ( ). This function returns an error if the caller is not a registered application or another OSD routine. Periodically, this function will verify that the SHA1 digest of the caller's code has not changed since it was registered.

int OsdEnrollGenerateRequest (OUT unsigned char *pPubKContainerBuffer, IN/OUT unsigned int *pPubKContainerBufferLength)

This function will generate a pseudo DMK, client seed of the master key and session master key. It return a sealed PubKContainer with client seed of the master key and session master key and a sealed AppContainer with session master key. The PubKContainer will be send to the Device Authority server. The BIOS will save the client seed and master key in SMRAM. On input, pPubKcontainerBuffer and pAppContainerBuffer point to buffers. pPubKContainerBufferLength and pAppContainerBufferLength point to locations that have the lengths of the buffers. On output, the buffers should be filled in with the returned Containers.

This function returns if successful otherwise return error. This function uses IOCTL_OSD_ENROLL_GENERATE_REQUEST to invoke OSD service.

int OsdEnrollProcessResponse (IN unsigned char *pContainerBuffer, IN unsigned int *pContainerBufferLength, OUT unsigned char *pAppContainerBuffer, IN/OUT unsigned int *pAppContainerBufferLength, OUT unsigned char *pPubKContainerBuffer, IN/OUT unsigned int *pPubKContainerBufferLength)

This function calls SMI routine to generate the master key and save it in SMRAM. The routine will create a Sealed AppContainer that has the Key ID (a hash of the DMK) and other data.

On input, pContainerBuffer points to a buffer that stores the MKContainer sent back by the Device Authority server during on-line enrollment or a SignedContainer that has the pseudo server seed during off-line enrollment. pContainerBufferLength specifies the length of the buffer. On output, pAppContanerBuffer stores the sealed AppContainer that contains the Key ID. PPubKContainerBuffer points to a buffer that contains the server seed and client seed during off-line enrollment. This pointer can be NULL during on-line enrollment.

This function uses IOCTL_OSD_ENROLL_PROCESS_RESPONSE to invoke OSD service.

int OsdInvalidateDMK( )

This functions invalidates the master key generated by the previous enrollment. This function uses IOCTL_OSD_INVALIDATE_DMK to invoke OSD service.

int OsdSetPublicKey(IN unsigned int nKeyIndex, IN unsigned char* pKeyBuffer, IN unsigned int * pKeyBufferLength)

This function either replaces the RSA public key specified by nKeyIndex or add a new key in the BIOS key table. On input, nKeyIndex specifies the key to replace or add. pKeyBuffer points to the key buffer. pKeyBufferLength indicates the buffer length.

OSD Internal Functions

The following functions are called by the OSD driver internally. They are not exposed to the user applications.

int OsdInitialize (void)

This function initializes the state of the operating system driver. The operating system driver calls this function after it is loaded into the system. This function registers with the BIOS layer and initializes the PRNG. The PRNG is initialized by zeroing StateBlock, reading the saved entropy from the semaphore file, converting it to binary and passing it to the OsdRandomAddSeed function. If there is no saved entropy, then the operating system driver performs a slow process of gathering entropy bytes, call OsdRandomAddSeed and then use OsdRandomSaveEntropy to save the entropy into the semaphore file.

int OsdRandomAddNoise (void)

This function is called at the end of every one of the OSD Security routines. It helps increase the unpredictability of the global PRNG by adding global information that is somewhat unpredictable to an attacker.

Call OsdDigestInit with new context.

Call OsdDigestUpdate passing StateBlock

For each quick entropy source:

Call OsdDigestUpdate passing the quick entropy value (32-bit or 64-bit value)

After the last quick entropy source is processed, Call OsdDigestFinal producing ResultBlock

StateBlock=StateBlock XOR ResultBlock

The quick entropy sources include the CPU cycle counter, CPU statistics such as cache miss count, and the all the bits of the system clock. The new StateBlock is the result of an exclusive-or of the old block and a digest value. By mixing the old block into the new block with exclusive-or, we ensure that the unpredictability of the new state is no less than the old state (assuming modest properties for the digest function). In contrast the equation: StateBlock=SHA1 (StateBlock) may cause the amount of unpredictability to shrink because SHA1 behaves like a random function that can cause two input values to map to the same output value. There are fewer possible outputs with each iteration.

If the motherboard or CPU supports a hardware RNG, then this hardware value should be included. Only add the amount of randomness that is quickly available.

This function returns an error if the caller is not a registered application or another OSD routine. Periodically, this function verifies that the SHA1 digest of the caller's code has not changed since it was registered.

int OsdRandomAddSeed (IN unsigned char *pDataBuffer, IN unsigned int *pDataBufferLength)

This function updates the state of the operating system driver's PRNG. It performs the following steps.

StateBlock=StateBlock XOR SHA1 (StateBlock∥pDataBuffer)

That is, initialize a SHA1 context and update it with the StateBlock and the bytes in the given buffer.

Call OsdRandomAddNoise ( )

This function returns an error if the caller is not a registered application or another OSD routine. Periodically, this function will verify that the SHA1 digest of the caller's code has not changed since it was registered.

int OsdRandomSaveEntropy ( )

This function saves information from the operating system driver's global PRNG into a field of the Semaphore file. It does not save the raw StateBlock, since that could cause the operating system driver to reuse the same sequence of random bytes. Instead, it saves a 32-byte (256-bit) value generated from the current (160-bit) state. Restarting the PRNG from that value will not cause it to regenerate the same bytes. The basic steps are:

Call OsdRandomGenerate requesting a 32-byte buffer of random bytes

Encode these binary bytes into 64 hexadecimal ASCII characters

Save these characters in a field of the Semaphore file.

Call OsdRandomAddNoise ( ).

This function returns an error if the caller is not a registered application or another OSD routine. Periodically, this function will verify that the SHA1 digest of the caller's code has not changed since it was registered.

Data Formats will now be discussed. The following is a description of the data structures and formats used in the present invention.

The Authorization Buffer is a SignedContainer. The Data block in the container defined in Table 12. The entry of the Registered Application Table is shown in Table 13. The table can be implemented as a linked list.

The following issues are addressed by the present invention. One issue is how to read the application code from the operating system driver. As long as the kernel mode OSD runs as a top level driver and in PASSIVE_LEVEL, it can read User Mode address space.

Another issue is how to get the caller's entry point. When an app calls DeviceIOControl system function, it will switch from ring3 to ring0. And for different ring the hardware implements different stacks. The operating system driver needs to trace back to the user mode stack to get the entry point. That relies on the implementation of DeviceIOControl, i.e., how many stack frames(function calls) it has. The following four possible solutions are available. (1) Emulate the instructions, e.g. through exception. (2) Call BIOS routines directly from User mode instead of going through the driver. (3) Setup INT gate. Set up an interrupt handler. all the functions will be caller by the soft interrupt. (4) Verify and Execute user code in OSD space. This solution will have the same problem as Win32 API.

Presented below is a description of the application registration module (ARM) component in the MFCA VPN product. The application registration module assists a Strong Authentication Module (SAM) in providing access to the secure AppContainers that are exchanged between the client devices and cryptographically-enabled servers.

The application registration module is responsible for providing the AppContainer Keys for client devices that have been enabled for access to a server application, such as a VPN. The application registration module will communicate with the SAM over a secure communications channel, such as SSL.

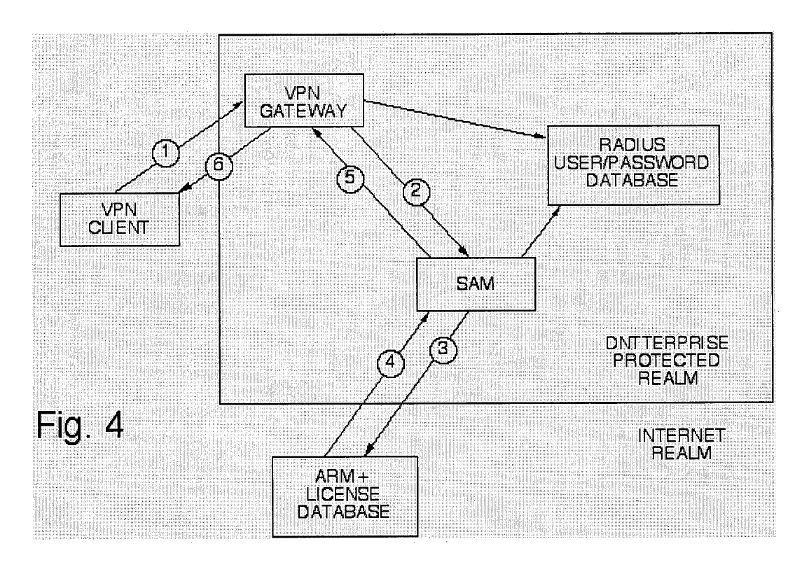

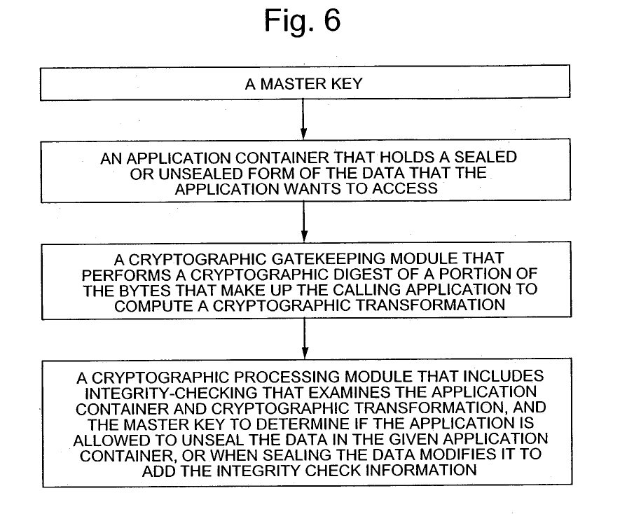

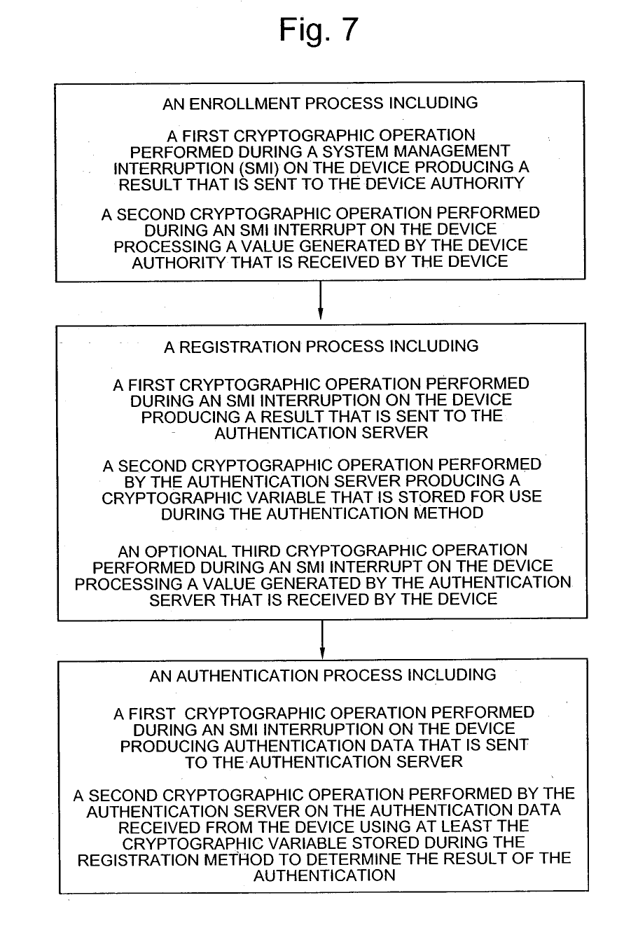

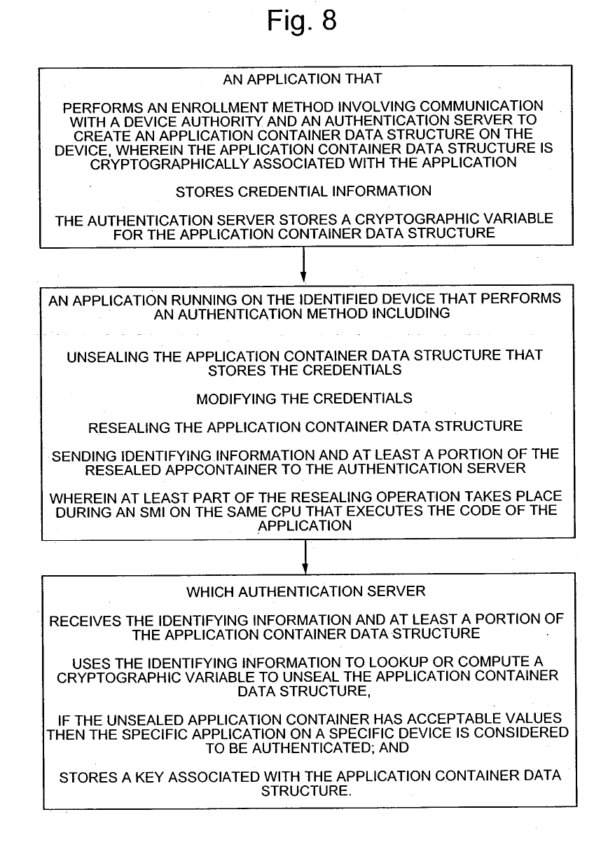

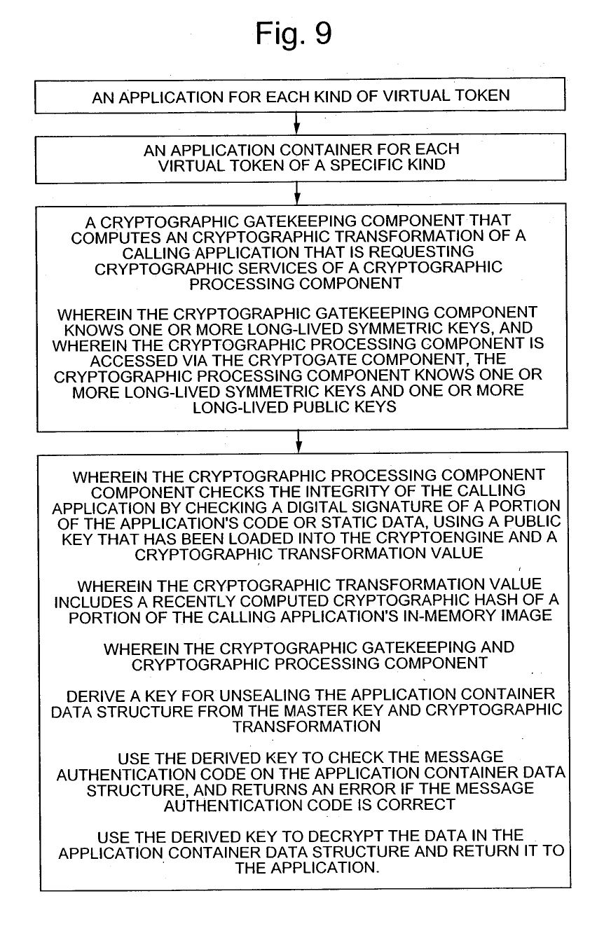

FIG. 4 is a block diagram illustrating multi-factor client authentication (MFCA) registration. FIG. 4 shows how the various modules interact with the application registration module

The SAM and application registration module have a client/server relationship. The Application registration module is an Internet server that will expose a number of services to the SAMs of different enterprises. Its purpose is to help the client and the SAM during registration of a particular device with a particular enterprise. The ultimate result is to provide the SAM with the appropriate App Key to seal and unseal containers in the device that is being registered. This operation is only performed once for each device/enterprise combination.

The components are invoked in the following order. The SSL connection verifier checks that a legitimate SAM is talking to the application registration module via an SSL connection. All other forms of connection to the application registration module should be redetected. The AppContainer Key provider will use the received pubKContainer to first perform some checks on the enterprise, then secondly prepare the AppContainerKey that will, finally, be sent back to SAM.

Entry points to the application registration module include specific URLs, such as AppContainerKeyRequest.

https://arms.DeviceAuthority.com/arm/AppContainerKeyRequest, for example, a URL that has in its body the PubKContainer( ) generated by the client system and some extra information provided by the SAM.

Theory of Operation of ClientCertificates

The application registration module webserver's mod_ssl is configured to know the Device Authority RootCA certificate. Mod_ssl checks that the presented SAM.ClientCertificate has a certification path that leads to the Device Authority. RootCA. For example: SAM.ClientCertificate was issued by SubscriptionManager.CA.cert, this Subscription Manager.CA.cert was issued by the Device Authority Root CA certificate. This last cert being configured into mod_ssl, will successfully terminate the checking of the SAM.ClientCert.

During this check of the certification path, mod_ssl will consult the Certificate Revocation List (CRL) that has been configured. The CRL will have to be updated each time a SubscriptionManager revokes a SAM (e.g., the company that purchased the SAM is going out of business). The Subscription Manager will have a URL where it stores its CRL. This URL is stored inside the SAM.ClientCert. The application registration module will get the file from this URL regularly.

Authentication is provided by the combination of the Device Authority RootCA and Subscription Manager.CA: a SAM.ClientCert is by construction a certificate of a SAM. This would not be the case if we were using Verisign as a RootCA.

Authorization is provided by the combination of the Device Authority RootCA, Subscription Manager.CA, and Subscription Manager.CRL: a SAM is authorized to contact the application registration module if it has a SAM.ClientCert AND it is not on the Subscription Manager.CertificateRevocationList.

SSL connection verifier. This is a java class that is invoked from servlets. It offers servlets an API to confirm the authentication information of the given connection. The servlet will pass it at least the request object as it holds the information about the ssl connection. Using that information the SslConnectionVerifier will determine whether the client that connected is a previously registered one.

The connection verifier logs any failed attempts. Successful attempts are logged for debugging purposes. The Verifier returns an object that will provide information on the client (SAM) that is connecting. The Verifier also grabs any username information that is available from the request. This is used by the ClientCert manager servlets.

The input is a Servlet Request Object: It holds the SSL client certificate information and information on user if a username/password was used to make this request. The output is a SslConnectionVerifier object: with methods such as IsSslOk( ), GetCertInfo( ), IsUserAuthenticated( ), GetUserInfo( ). The SslConnectionVerifier has access to all the fields of the x509 Client Certificate.

AppContainerKey Provider servlets hands out keys for the application registration module. It is the main entry point of the ARM module. It invokes the SslConnectionVerifier. From its input stream it receives a pubkc( ) that holds information on the SAM that forwarded the pubkc( ) of the client device. This SAM information has an enterprise field that is consistent with information that the SslConnectionVerifier object knows. Invoke the Enforcer, passing it all the information from the SslVerifier and also information from the pubkc( ). Based on the Enforcer's result this servlet will then request an AppContainerKey from the crypto-engine. The Key ID+ACD that were in the pubkc( ) will be passed to the crypto-engine. The AppContainerKey is returned to the SAM over the SSL connection.

Input is an InputStream (from servlet API) with PubKC( ) holding a Key ID, enterprise information, and an ACD. A request object (from servlet API) that holds information on the current connection (SSL, . . .). The output returns an AppContainerKey on the outputStream (from servlet API), and modifies the number of used licenses in the database.

28. The Subscription Manager

The Subscription Manager gathers information that is required for the Strong Authentication Module (SAM) to manage licenses. These licenses control the number of AppContainersKeys that can be requested by the SAM from an Application Registration Module (ARM) in the MFCA product. The application registration module is responsible for providing the AppContainer Keys for client devices that have been enabled for access to the VPN.

Sales people that are allowed to sell licenses to companies that purchase SAMs will typically use a Web user interface to the Subscription Manager. This interface gathers information on the company, the number of licenses, their expiry date, the sales person ID, and the SAM identification (Client Certificate Signing Request) that will be used by the application registration module to determine what SAM is requesting an AppContainerKey.

The subscription manager generates a tamper proof (signed and/or encrypted) file that the SAM will load and verify. This file contains the subscription information (i.e. number of licenses that are allowed to be in use, the allowed IP address of the SAM . . .). In addition to the Subscription Information File (SIF) the subscription manager also returns the signed SAM's identification.

The subscription manager is a front-end to a database of license information and client certificates. The web user interface authenticates the license reseller using client certificates. It requests the following information on the company that the reseller is getting license for including: Company name, Company Contact information, Number of licenses, Licenses validity dates (from start date to end date), IP or MAC address of the SAM (to bind the Subscription File to that SAM), SAM's Client Certificate Request (CSR), and Reseller identification.

The subscription manager produces the following items that are forwarded securely to the person installing the SAM: a signed Client Certificate, and a tamper proof Subscription Information File (SIF). Having the SIF signed by a SIF Singing Utility (SSU) will do the tamperproofing.

Internally the Subscription Manager will update a database with the following information: information required for revoking the SAM's Client Certification, information on the SAM (number of licenses, expiry date, contact information for license renewal . . .), and information on the company that purchased the SAM, as it might not be the only SAM that company owns.

The theory of operation of the subscription manager is as follows. First a contract is established between a reseller/channel-partner and a Device Authority. Then the License-Reseller info editor/viewer is used by somebody at the Device Authority to create an initial Reseller/Channel-partner account that will be authorized to sell licenses to SAMs.

This produces a user/password that gets communicated to the reseller/channel-partner. The reseller/channel-partner arranges for a SAM to be installed in some company. He logs in to the SAM info editor/viewer and enters the company information and the licensing information.

The company finishes installing the SAM: the company has assigned an IP address to SAM and has generated a Client Certificate Signing Request. This information is passed on to the reseller. The reseller (or the company with the OTP) then returns to the SAM info editor/viewer and enters the IP address of the SAM and the CSR.

The server generates the unsigned SIF and sends it to a SIF Signing Utility. The SSU immediately returns the signed SIF. The SAM's CSR is turned into an actual Client Cert signed by the Subscription Manager that is acting as an intermediate CA on behalf of the Root Device Authority.

Without the OTP solution, the reseller communicates the SIF and Client Certification to the company. The company then installs the SIF into a directory known by the SAM. The Cert gets installed into their SSL module. The company is now ready to request AppContainerKeys.

28.1. SAM Module Component Details

An SSL connection verifier is a java class that is invoked from servlets. It offers servlets an API to confirm the authentication information of the given connection. The servlet passes it at least the request object as it holds the information about the ssl connection.

Using that information, the SslConnectionVerifier determines whether the client that connected is a previously registered one. Probably this verification will be limited to checking that the connection is over SSL and that the client has a certificate. This simplicity will be due to how Apache+mod_ssl will be configured: they only accept connections from clients with a known certificate.

The connection verifier logs any failed attempts. Successful attempts are logged for debugging purposes. The Verifier returns an object that provide information on the client (resellers computer) that is connecting. The Verifier also grabs any username information that is available from the request. This will be used to verify that the actual authorized reseller is using his computer and not some computer this.

The input is a Servlet Request Object, which holds the SSL client certificate information and information on user if a username/password was used to make this request. The output is an SslConnectionVerifier object: with methods like IsSslOk( ), GetCertInfo( ), IsUserAuthenticated( ), GetUserInfo( )

The SAM info editor/viewer module allows licensing information to be added/edited/removed, and so forth. It allows the generation of reports per company, per SAM IP/MAC address, per soon-to-expire licenses, for example. All actions are authenticated with valid reseller information (username/pwd, client cert).

The SIF generator module generates a Subscription Information File. The generated SIF is sent to the SIF Signing Utility (SSU). The SSU will sign the file using the private key who's matching public is shipped with the SAM software. There is only one SIF signing key pair.

The SIF is a human readable file. This allows IT department personnel to instantly have access to contact information as well as dates, IP addresses, etc. during support. The SIF contains: Company name, Company Contact information, Contact for expired licenses, Number of licenses, Licenses validity dates (from start date to end date), Reseller identification, IP or MAC address of the SAM (to bind the Subscription File to that SAM).

A Certificate Signing Request (CSR) handler module is responsible for creating X509 compliant Certificates signed with the Root Device Authority's key. It only signs certificates if the reseller that has submitted the request is correctly authenticated (username/password and client certificate is authorized). It requires SAM information, the corresponding CSR, and contact information to remind of the expiry of the SAM's client certificate. The CSR contains the IP address of the machine in one of the fields. therefore it is the responsibility of the SAM installer to generate a client certificate with the IP address in one of the fields.

The output is an x509 client certificate useable on the SAM machine. Openssl is the underlying tool that handles certificate matters on the SAM and the subscription manager. This module also handles revocation of issued SAM.ClientCertificates. The revocation information will be put into a Certificate Revocation List (CRL). This list can be manipulated using opensll. This CRL file is available for download for anybody via HTTP on this server.

A license expiry detector regularly scans the database of licenses and sends an email to the contact provided during subscription. A SAM certificates expiry detector regularly scans the database of generated SAM client certificates and send an email to the contact provided during CSR.

A License-Reseller info editor/viewer registers resellers with the system and provides them with a Client Certificate for their browser or just a username and password or both. It also allows tracking of how well a reseller is performing in sales.

A SIF Signing Utility (SSU) provides an easy way for a Device Authority to get access to the subscription information. At a minimum, the SSU signs the SIF.

29. Application: Multi-Factor Client Authentication

One application of the system is a multi-factor client authentication (MFCA) application for accessing a virtual private network (VPN). The first part of the authentication process is a username/password pair (something the user knows). The second part will be the authentication of a cryptographically-enabled device, either BIOS-based or using software (something the user has).

In a simple version of MFCA, password verification is achieved by a traditional transmission through RADIUS to an authentication server that uses a legacy password database. In preferred embodiments this process is enhanced using a SPEKE password authentication protocol disclosed in U.S. Pat. No. 6,226,383. In both cases, MFCA provides a new mechanism for device authentication.

The system includes the following software components. A client software component running in the client device that authenticates to a VPN server. The software must be cryptographically-enabled.

A software component running on one or more server machines of the VPN that we are protecting, inside the enterprise-protected network. This is administered by the IT department of a company that purchases the VPN product.

A software component running on a Device Authority server (which may be administered by an authority other than the enterprise) connected to the Internet and with access to a database of KID/DMK pairs.

An MFCA overview is provided discussing an enhanced VPN client. The client device is typically a Windows machine that enrolls with a Device Authority. After enrollment the client device has a valid master key. In a preferred embodiment it has firmware support, with cryptographic features of the present invention implemented in BIOS ROM, although a software-only version may be used. The machine typically is owned by the user of the client VPN software who wants to access the restricted network of his company through the VPN gateway.

The client typically accesses the Internet through a regular Internet service provider (ISP). The network between this ISP and the VPN gateway is not trustworthy, so communications between these two parties must be secured. The primary purpose of the VPN solution is to provide end-to-end cryptographic security from the client device to the VPN gateway.

The MFCA client includes the cryptographic core technology implemented by the present invention and a client application that cooperates with standard VPN client software to establish the secure link with the server. The MFCA architecture requires that the machine be enrolled prior to VPN login. The client application discovers during the first time it runs whether or not the client has been previously enrolled. If it has not previously enrolled, the client application performs enrollment, and only after this is completed, will it continue with the rest of the MFCA operations.

An Enterprise VPN gateway and Strong Authentication Module (SAM) is provided by the present invention. The MFCA-enabled enterprise has a VPN Gateway server attached between the Internet and the protected network of the enterprise.

The VPN typically includes a number of machines that cooperate between them to grant access and block untrusted traffic. Normally they work in conjunction with a firewall. The important machines are the VPN gateway and the Strong Authentication Module (SAM) server.

The SAM stands inside the corporate network, and is essentially trusted. In some cases this means that the communications between the VPN Gateway and the SAM server need not to be encrypted. A simple security check for the two machines is to check on the IP address of the other one, where the routing that is done inside the corporate network is trusted.

The SAM is server software that interacts with the VPN gateway in granting access to the inner network for a particular user and device. It has access to a “database” of registered devices, that will be allowed access. The interface between the SAM code and the database should be as open as possible, to allow to place different database implementations under it (for example, by using ODBC or LDAP). Care should be taken with the SAM-Database connection, which may be implemented using the Secure Sockets Layer (SSL) protocol.

The SAM contains the code that seals and unseals App Containers. The SAM Server may also incorporate tracking of licensing policies (expiration of device rights to access the network, number of devices to allow in, etc.). The cryptographic functions may be provided in both BIOS-ROM and software-only forms.

In addition to these machines, additional hardware and/or software may cooperate with the Gateway and the SAM in determining whether a device/user pair should be granted access (the first part of the two-factor authentication). A variety of standards and products are used in the industry to perform this function, including RADIUS servers that have access to databases of usernames and password, and various systems for determining policy-based access rights.

The SAM component may also be used to enforce a software licensing scheme. The SAM component is typically administered by the IT department of the enterprise that owns the VPN, and not by any other authority. However, it may have a trust relationship with another authority that has sold the enterprise the rights to use the MFCA software.

The licensing policy takes into account expiration times for the whole account of the enterprise, or for individual client accounts (for example, someone may lose his laptop, and we have to delete that device). The SAM implements these revocation and expiration according to policies set by the system administrator.

Licenses can be based on a maximum number of devices that will be granted access to the database. The license functions periodically audit and track what is happening. This may involve the SAM sending information to a vendor-specific location on a regular basis. License management is preferably done from a remote Web based tool.

The Application registration module (ARM) is an Internet server that exposes services to the SAMs of different enterprises. Its purpose is to help the client and the SAM during registration of a particular device with a particular enterprise. The ultimate result is to provide the SAM with the appropriate App Key to seal and unseal containers in the device that is being registered.

This operation needs to be performed only once for each device/enterprise combination, during a process called “MFCA Registration”. The application registration module server consists of some front-end server(s)—presumably, but not necessarily, Web Server(s)—, communicating with a backend database that holds information describing the valid licenses for different companies at the time, what their expected certificates are, etc.

License-enforcement may be done here. Basic tracking of the number of registered users for a particular enterprise is one example. The application registration module server performs license enforcing and license logging and auditing, but does not track individual logins. The application registration module also has access to a Device Authority “Encryption Server” that stores the KID/DMK table generated during the process of Enrollment. A Web based remote interface handles these enterprise accounts.

As an enhancement utility for the application registration module, the data entry is automated by a web interface (Subscription Manager) that allows resellers, channel partners, and IT administrators to enter the appropriate information to enable the SAM to interoperate with the central ARM database. The processes listed in the following table are involves.

| Process name | Description |
|---|---|
| MFCA Subscription | Process that generates licensing |
| | information for a SAM. The sales person |
| | that sells licenses initiates the subscription |
| | process by logging into a Device Authority |
| | owned server called the Subscription |
| | Manager. The sales person enters |
| | information about the company that bought |
| | the SAM: how many licenses are |
| | requested, the SAMs Client Certificate, and other |
| | information, . . . |
| | The output of this process is a Subscription |
| | Information File (SIF), and a Client |
| | Certificate (see Certificate). |
| Enrollment | Process by which a client device acquires |
| | an DMK and is able to use cryptographic |
| | services. This process involves the client |
| | device and the Device Authority |
| | Enrollment Server. |
| | Enrollment need the client device to |
| | contain the cryptographic core functions, |
| | either in BIOS or in the Emulation API. |
| MFCA Registration | Process by which a client device gets |
| | registered to use the services of the VPN of |
| | a particular enterprise. This involves the |
| | client, the SAM Server, and some |
| | interaction with the ARM Server. |
| | Registration requires that the client device |
| | has previously performed enrollment with |
| | the Device Authority. |
| | The ultimate purpose of this registration is |
| | to provide SAM with the appropriate App |
| | Key to seal and unseal App Containers that |
| | will be exchanged with the client device. |
| Login | Process by which a client device gains |
| | access to the internal network of an |
| | enterprise. This is the final service that |
| | MFCA wants to accomplish. The login |
| | involves some interaction between the |
| | client device and the SAM Server, but no |
| | additional interaction is required with |
| | Device Authority. |
| | The SAM Server has to authenticate the |
| | client device as the second phase of a two- |
| | factor authentication with the VPN |
| | Gateway. It uses App Containers to |
| | perform this. |

In addition to the above, the VPN client, the SAM Server, and the ARM Server have to be configured to be able to hand out the appropriate App Keys successfully.

The process of registration involves the following two steps: (1) transmission of the App Key that works with a particular machine, from Device Authority to the SAM server of our corporation, and (2) transmission of the Customer Secret that generates the Customer App Key, from the SAM server to the client.

The App Key is a function of the following: (1) the DMK of the machine that is being registered (known only by the Device Authority and the machine itself), and (2) the operating system driver of the application (the VPN Client application, in this case).

The App Key is the result of the following cryptographic operation:

ApKey=trunc128(SHA1(DMK∥ACD)).

The SAM server generates an additional 128-bit secret, the Customer Secret, that is kept secret from other Device Authorities, and computes the Customer App Key with the following operation:

CustomerAppKey=trunc128(SHA1(AppKey∥CustomerSecret))

The SAM server stores this value (or, optionally, stores the App Key and the Customer Secret separately), and sends the Customer Secret to the client. The client records this secret (although this is not a “big secret” as is the DMK). The SAM also sends to the client a sealed App Container that may store an initial value for a Login Counter mechanism. In an alternate embodiment, a secure challenge/response mechanism replaces the Login Counter mechanism.

The process of logging in is based on App Containers. The client unseals the App Container that it has previously received, increments the login counter, reseals the container and sends it to the VPN Gateway as part of the VPN Authentication Protocol. The SAM server gets this container, opens it, and compares the login counter with the last recorded value. If it is inside an acceptable range, it will grant the calling client access to the internal network of the enterprise.

In an alternate process of login, the client receives a random challenge value from the VPN Gateway, unseals the App Container that it has previously received, combines the Customer Secret and the challenge value with a one-way function (typically using a cryptographic hash function, like SHA1), and returns the result of the one-way function to the VPN Gateway as part of the VPN Authentication Protocol.

The SAM server gets this result, and compares it to its own computed result of the one-way function of the challenge value and the Customer Secret. If the SAM server's computed result matches the client's result, the VPN Gateway will grant the calling client access to the internal network of the corporation.

Specific implementations of the MFCA may target particular VPN software products. Some VPN vendors provide APIs that allow other companies to customize their product in the client, as well as in the server. These vendors may also have certification programs for software that has been written to interact with these APIs. The MFCA may be delivered in either an add-on form or in an integrated form with VPN vendors products.

30. Detailed Enrollment Processes

Enrollment is a pre-requisite to the MFCA installation. The client device must have the core cryptographic system, including the operating system driver (OSD), a low-level driver program which accesses the BIOS and the hardware, and the device must have already been enrolled and have stored a valid master key.

The enrollment operation may be performed as part of the VPN software installation. That is, if the client device has not yet been enrolled when the client tries to access the VPN for the first time, it can perform enrollment there and then. This will happen as part of the initial user experience when he starts the client application for the first time. No input from the user is needed.

Client setup Involves the user receiving software that contains the MFCA VPN Client, which may be an enhanced form of an existing VPN Client including additional code for MFCA setup and MFCA-enhanced login authentication. Preferably, the APIs provided by the VPN vendor's client SDK should allow the MFCA code to be linked with their libraries statically. Ideally, all of the relevant parts of the MFCA product are inside the range whose ACD is calculated.

The server setup process will now be discussed. Strong Authentication Module (SAM) configuration: Setting up user/device accounts. This is typically performed by the enterprise system administrator. The SAM interacts with the VPN and/or with the authentication server. A number of options are available here:

The SAM may be a plug-in for an existing authentication server. The interface between authentication server and SAM is an API. The SAM is a server listening to some port, understanding either a custom protocol or RADIUS. The interface between authentication server and SAM is a network protocol.

VPNs and RADIUS servers are also highly configurable, permitting a number of configurations. The RADIUS server (in case it is present) authenticates clients depending on policies, usernames and passwords, etc.

The SAM takes care of authenticating the device. A simple embodiment includes a standalone RADIUS server, and can be used to talk directly to the gateway, or to another authentication server acting as a proxy. The configuration user interface (UI) will be independent of any other authentication server.

VPN Gateway/RADIUS server configuration. The admin configures a username/password pair. This will be the “permanent” username/password pair for the user to login. This process does not involve any Device Authority, and is the “usual” one-factor configuration independent of MFCA.

SAM configuration. The administrator configures a username, Application Device ID (ADID), and Registration Password. In alternative embodiments, the administrator may also create associations between users and devices to indicate valid combinations, to restrict users to authenticate from specific machines.

The Application Device ID (ADID) is a human-readable public name, a unique value within each enterprise, but not necessarily across enterprises. The Registration Password is generated by the system administrator. It must be a truly random number.

In an alternate embodiment one could use the Key ED as a unique identifier to act in the place of the ADID. However, in practice people mistrust the idea of a universal “unique identifier”, so the preferred embodiment uses a separate ADID chosen by an IT administrator. All passwords that are stored in the SAM database are hashed.

The model described in this architecture implies that the database of users and the database of devices are separated. This has the consequence that any user that exists in the users database will be authenticated with any device that exists in the device database. No restrictions are enforced for specific users to be linked with specific machines.

MFCA registration (first connection). The user, obtains a username/password pair and an ADID/Registration Password pair from the IT department of his enterprise. The user experience is as follows.

The user runs an installation application. This is a generic Windows install. If client is not enrolled, the enrollment operation is performed. The installation program prompts the user for the pieces of data that will identify the user to the VPN. The username/password for normal login, and the ADID/Registration Password for registration.

The user connects for the first time, the VPN gateway/RADIUS authenticate the username/password pair and checks the current policies to allow him in. SAM registers the device with the external ARM server, and configures itself. If everything is successful, the user will be in the VPN.

In subsequent logins, the user will not need to enter his ADID/Registration Password any more. Client VPN App should only prompt the user for a username and password. The client remembers the ADID, and the location of the App Container and the customer secret it has received from the server.

The overall server interaction flows are as follows. Reference is made to FIG. 4 which is a block diagram illustrating an MFCA Registration.

The client application makes the first request to the VPN gateway, using the pre-existing VPN protocol. The VPN gateway checks the username and password pair in the usual way with the RADIUS server using the pre-existing method of authentication. The VPN gateway then determines that the client needs registration with the SAM Server. The VPN gateway forwards the request to the SAM Server.

The request contains: (1) in the open, the ADID, (2) a PubK Container encrypted with the Communication Public Key of the appropriate Device Authority server, that contains the enterprise name/URL, and the ACD for the App (or an ID that identifies the ACD in the ARM database).

SAM cannot decrypt the PubK, so it passes it to the ARM Server. This connection must provide some kind of authentication of the SAM to the application registration module. In an HTTPS implementation, a Device-authority-issued certificate is presented to the SAM server, and vice-versa, where the certificates are established during the process of opening the account with the Device Authority.

The application registration module opens the PubK Container using the private bit of the Communication Key, and updates its internal tables with the new device ADID, if necessary. The application registration module checks the enterprise against its database to find out if it has a valid license. If everything is all right, the application registration module has the Key ID of the client device, so it finds the DMK, and computes the App Key for the given ACD. It then transmits back this App Key to the SAM, in a secure way (perhaps using the response of the HTTPS connection).

The SAM stores the App Key against the ADID, builds the Customer App Key with the App Key and a new random value for the Customer Secret (or alternately the SAM stores directly this Customer App Key and forgets about the App Key), and builds the initial App Container, storing there the initial 128-bit Login Counter (its initial value can be the registration password), and the enterprise name/URL.

The SAM seals the AppContrainer and passes it and the Customer Secret back (perhaps via the VPN Gateway) to the client. This App Container does not need to be sent to the client encrypted. Visibility of it does not compromise anything. An eavesdropper cannot record it and send it to the server to try and gain access to the VPN, as the container will have the wrong value of the counter.

The VPN Gateway receives the Ok from the SAM Server, and now grants the client access to the internal enterprise network. The client stores both the App Container and the Customer Secret in a well-known place.

The application registration module handles out App Keys, but we do not know the Customer Secret and the initial value of the Login Counter—they are known only to the SAM. This ensures the NFCA-enabled enterprise that, although a Device Authority helps provide the security, it cannot masquerade as a client device and enter the enterprise without authorization.

Client device. A dialog window asks for username and password, and Enterprise/URL identification. The user does not need to enter the ADID again, because it is remembered by the system. Client machine contacts the VPN gateway and authenticates the username/password pair in the normal way (via RADIUS or whatever).

VPN gateway finds out that the client requires additional authentication, and requires it to authenticate itself. The client unseals its App Container (using the Customer App Key, computer from the App Key and the stored Customer Secret), increments the Login Counter (128 bits, not allowed to be negative), seals it again and sends it to the gateway, accompanied by the ADID in the open. Once the VPN gateway has the App Container, it passes it to the SAM Server for authentication. Client waits for completion. If the gateway returns an error, it will prompt the user in his language. If everything is Ok, the VPN software can start operating.

The Strong Authentication Module (SAM) receives a request for authentication from the VPN Gateway, accompanied by the ADID of the client, and its App Container. It looks up the Customer App Key and the expected value of the counter using the ADID as index. It unseals App Container using Customer App Key.

It checks a counter and extra information. The SAM should allow a range of counters. If (Cexpected<=Cactual<Cexpected+10), authentication will be Ok. The purpose of this is to cover the case when packets get lost from the client to the server (a user hitting the “retry” button may times, for example).

An error occurs if the check is out of range. It sends an error code, and error parameters. If it a success, it stores new counter, and sends the “Authorization Ok” message to the VPN Gateway. Errors are logged, and a report are presented to the system administrator periodically. The SAM may alert the administrator in special circumstances, such as in the event of many failed attempts to connect, which may indicate that someone is trying to attack.

The system is designed to defend against a primary threat model of an untrustworthy software application causing corruption or misuse of the system and/or the secret keys of the system. In preferred embodiments that utilize SMI and other related hardware mechanisms, the threat model is extended, and the system further protects keys against untrustworthy programs running in “ring zero”, essentially portions of the operating system itself.

Threat model, attacks and recovery. Below is a discussion of a number of identified threats, their scope, and how they are addressed by the system.

An eavesdropper stealing the App Key. An eavesdropper may listen in to the ARM/SAM communication and steals the App Key. However, he will not be able to masquerade as a client, because he also needs at least the Customer Secret and the initial value of the VPN Counter.

Stolen App Key and the Customer Secret. Presume a hacker steals the App Key and the customer secret, possibly because he has broken into a corporation and stolen all the data inside the ADID database. If the theft is detected, this can be solved by re-registering the machine to produce a new Customer Secret (although the App Key cannot be changed). If the enterprise retains the App Keys, it may not need to re-register again

Threat slowdown. The hardware-based chain of security benefits that the preferred embodiment of the present invention has may not exist for the software-only embodiment.

The preferred embodiment of the present invention is designed such that no software-based reverse engineering tool can hack it. Furthermore, a hardware-based attack does not enable an enemy to crack other physically remote machines. This protection is achieved by using the CPU's System Management Mode (SMM).

From within the SMM, the next layer of software (i.e., the operating system driver (OSD) using the cryptographically-enabled BIOS) is verified for tampering. This OSD code is made tamper-evident—it cannot be modified to let a rogue application use it without being detected by the SMM code. This verified operating system driver in turn checks that the application has not been modified.

To frustrate attach when secure storage locations for the master key are not available, or when secure storage mechanisms are available but have not all received a high level of assurance, the DMK will be split into shares that are stored in multiple locations. Also, only a limited number of shares may be required to get back the DMK, using Shamir's secret sharing scheme.

Furthermore, key shares may be encrypted using a key based on one of device-binding properties (e.g. the drive serial number, the graphics card driver version, etc.). As device property keys may be small or predictable, the encryption is chosen so that it takes a large amount of time to decrypt based on the size of the key, using iterated cryptographic operations.

The DMK shares are re-combined each time the DMK is required. The joined DMK would be referenced in memory with a pointer that references a new memory location at each joining. Each time the DMK pieces are joined a check is made to see whether some of the pieces are no good. Tracking the previous values of device-binding information allows detecting a no-good share. In the case of an invalidated share the DMK is re-shared.

DMK/device binding. One of the requirements of software-only embodiment of the present invention is the ability to detect when an attempt has been made to move an master key and its App Containers to a new machine. In order to detect this movement, certain characteristics of the machine are recorded. When a few of these characteristics change at the same time, the software-only system detects this and acts upon it.

Limited master key and session keys exposure. The design limits the exposure of the DMK and the session keys when using them for any operation. In the preferred embodiment all such operations are performed in SMM, using memory that is unavailable when running outside of SMM.

Public key integrity. In simple embodiments, the public keys are included and compiled into the operating system driver. These may be the same public keys that are included in the BIOS.

Interaction of the VPN client with the TCP/IP stack is as follows. The client VPN is responsible for the following services: configuration of the VPN client, authentication to the VPN gateway, and encryption of packets sent to the internal enterprise network. The main job of the VPN client, once the login process is finished, is to inspect the packets that are sent to the network, to find out whether they are being directed towards a normal Internet machine, or to the enterprise-network.

The client inspects the destination IP address. If the packet is for a machine in the Internet, it goes without modification. If the packet is for the enterprise network behind the VPN gateway, the client encrypts it and (sometimes) performs some kind of address translation.

The client stack is a layered structure such as: TCP Stack/UDP Stack, NDIS interface (the setup configures this), IPSec (normally using DES and 3DES, symmetric established after some initial negotiation), and NDIS, again. The VPN Gateway that receives the packets will strip out the cryptography, and then they is in the clear inside the network.

In a preferred embodiment that uses SPEKE, both the client and gateway generate a new key that is tied to the authenticated user identity. This key may be used to strengthen the binding of the act of authentication to the VPN session key.

In several places of the above description, several variations were described that may be used within the architecture of the present invention. These include (1) binding users to devices, which uses enhanced policies for administrators to define valid specific combinations of users and devices, (2) encryption of passwords between the client and the gateway, between the gateway and the authentication server, and between authentication server and strong authentication module, (3) use a challenge/response mechanism instead of using a login counter; and (4) wrapping the client installation inside a integrated package that can be installed from a website.

Thus, systems and methods that provide for computer device authentication have been disclosed. It is to be understood that the above-described embodiments are merely illustrative of some of the many specific embodiments that represent applications of the principles of the present invention. Beyond the act of device authentication—authenticating keys for use on specific devices—the invention is broadly useful for many security applications. One example is device encryption, where files are encrypted on a hard drive using an AppKey. Clearly, numerous other arrangements can be readily devised by those skilled in the art without departing from the scope of the invention.

TABLE 1
AppContainer Structure

| Offset | Size | Field Name | Description |
|---|---|---|---|
| 0x00 | 1 bytes | OpCode | Indicates contents and format of the data field |
| 0x01 | 1 bytes | Format | FmtAppContainer = 2 |
| 0x02 | 4 bytes | Reserved | 0. This will be used in the future for extended opcode information. |
| 0x06 | 2 bytes | Length | Count of bytes from the AppCodeDigest field up to and including the |
| | | | Data field. Count of bytes after seal operation but before cipher text |
| | | | replacement. Count includes fields from ACD up to and including the |
| | | | Pad field. |
| 0x08 | 20 bytes | AppCodeDigest (ACD) | Result of the SHA-1 digest of owning code that has been encrypted by |
| | | | the Enc160 Bits primitive. |
| 0x1c | 16 bytes | Initialization Vector | Random initialization vector for Cipher Block Chaining (CBC) mode. IV |
| | | | passed in by the OSD Security module. |
| 0x2c | 20 bytes | Sealer CodeDigest | Result of SHA1 digest of code for the program that sealed this |
| | | (SCD) | container. Normally SCD is equal to the ACD. The SCD is set to zero |
| | | | if the container was sealed by the Device Authority server. It could |
| | | | also be the digest of another program if the program was authorized to |
| | | | transfer containers to this one. The SCD is passed in by the OSD |
| | | | Security module. |
| 0x40 | 0-4096 bytes | Data | Data with a format determined by the OpCode |
| Varies | 20 bytes | MAC | HMAC cryptographic primitive = HMAC (NewKey(Key, UsageAppMac), |
| | | | Payload) |
| Varies | 1-16[1] bytes | Pad | Number of Pad bytes is set to make sure that the Plain text is a multiple |
| | | | of 16 bytes. Each padding byte has a value equal to the number of |
| | | | padding bytes in the Pad buffer. |

TABLE 2
Structure Modifications during OSD AppContainer Sealing

| Field Name | OSD Sealing Phase before sending to SMI Layer |
|---|---|
| OpCode | Indicates contents and format of the data file |
| Format | FmtAppContainer = 2 |
| Reserved | 0. This will be used in the future for extended opcode informatic |
| Length | Count of bytes from the AppCodeDigest field up to and |
| | including the Data field |
| AppCodeDigest (ACD) | Result of the SHA1 digest of owning code that has |
| | been encrypted by the Enc160 Bits primitive. |
| Initialization Vector (IV) | Random initialization vector for Cipher Block Chaining (CBC) mode. |
| Sealers CodeDigest (SCD) | Result of SHA1 digest of code for the program that |
| | sealed this container. Normally SCD is equal to the ACD. |
| | It could also be the digest of another program if the |
| | program was authorized to transfer containers to this one. |
| Data | Data with a format determined by the OpCode |
| MAC | NULL |
| Pad | NULL |

TABLE 3
Structure Modifications during SMI AppContainer Sealing

| Field Name | SMI Sealing Phase I |
|---|---|
| OpCode | Indicates contents and format of the data field |
| Format | FmtAppContainer = 2 |
| Reserved 0. | This will be used in the future for extended opcode information. |
| Length | Count of bytes after seal operation but before cipher text replacement. |
| | Count includes fields from ACD up to and including the Pad field. |
| AppCodeDigest (ACD) | Result of the SHA1 digest of owning code that has |
| | been encrypted by the Enc 160 Bits primitive. |
| Initialization Vector (IV) | Random initialization vector for Cipher Block Chaining (CBC) mode |
| Sealers CodeDigest (SCD) | Result of SHA1 digest of code for the program that sealed this |
| | container. Normally SCD is equal to the ACD. It could |
| | also be the digest of another program if the program was |
| | authorized to transfer containers to this one. |
| Data | Data with a format determined by the OpCode. |
| MAC | HMAC cryptographic primitive = HMACNewKey(Key, |
| | UsageAppMac), Payload) |
| Pad | Number of Pad bytes is set to make sure that the Plain text |
| | is a multiple of 16 bytes. Each padding byte has a value |
| | equal to the number of padding bytes in the Pad buffer |

TABLE 4
Final Sealed Structure

| Field Name | SMI Sealing Final |
|---|---|
| OpCode | Indicates contents and format of the data field |
| Format | FmtAppContainer = 2 |
| Reserved | 0. This will be used in the future for extended opcode information. |
| Length | Count of bytes after seal operation but before cipher text |
| | replacement. Count includes fields from ACD up to and |
| | including the Pad field. |
| AppCodeDigest (ACD) | Result of the SHA1 digest of owning code that has been |
| | encrypted by the Enc 160 Bits primitive. |
| Initialization Vector (IV) | Random initialization vector for Cipher Block Chaining (CBC) mode |
| Sealers CodeDigest (SCD) | Result of SHA1 digest of code for the program that sealed |
| | this container. Normally SCD is equal to the ACD. It could |
| | also be the digest of another program if the program was |
| | authorized to transfer containers to this one. |
| Data | Data with a format determined by the OpCode. |
| MAC | HMAC cryptographic primitive = HMAC(NewKey(Key, |
| | UsageAppMac, Payload) |
| Pad | Number of Pad bytes is set to make sure that the Plain text |
| | is a multiple of 16 bytes. Each padding byte has a value |
| | equal to the number of padding bytes in the Pad buffer. |

TABLE 5
MKContainer Structure

| Offset | Size | Field Name | Description |
|---|---|---|---|
| 0x00 | 1 bytes | OpCode | Indicates contents and format of the data field |
| 0x01 | 1 bytes | Format | FmtMkContainer |
| 0x02 | 4 bytes | Reserved | 0. This will be used in the future for extended opcode information. |
| 0x06 | 2 bytes | Length | Count of remaining bytes with MSB first. For a sealed container this includes the |
| | | | length of the Mac and Padding bytes, for an unsealed container it does not include |
| | | | either the Mac or Padding byte lengths (i.e., it specifies the total byte length of items |
| | | | MKDigest through Data). |
| 0x08 | 20 bytes | MKDigest | 20 byte result of SHA1 digest of the master key. |
| 0x1c | 16 bytes | Initialization Vector | Random initialization vector for Cipher Block Chaining (CBC) mode. IV is |
| | | (IV) | passed in by the OSD Security module. |
| 0x2c | 20 bytes | Sealers CodeDigest | Result of SHA1 digest of code for the program that sealed this container. The SCD |
| | | (SCD) | is set to zero if the container was sealed by the Device Authority server. The SCD |
| | | | is passed in by the OSD Security module. |
| 0x40 | 0-64000 bytes | Data | Data with a format determined by the OpCode. |
| Varies | 20 bytes | MAC | HMAC cryptographic primitive = HMAC(NewKey(Key, UsageMKMac), Payload) |
| Varies | 1-16 bytes | | Number of Pad bytes is set to make sure that the Plain text is a multiple |
| | | | of 16 bytes. Each padding byte has a value equal to the number of |
| | | | padding bytes in the Pad buffer |

TABLE 6
Structure Modifications during OSD MKContainer Sealing

| Field Name | OSD Sealing Phase before sending to SMI Layer |
|---|---|
| OpCode | Indicates contents and format of the data field |
| Format | FmtAppContainer |
| Reserved | 0. This will be used in the future for extended opcode information. |
| Length | Count of bytes after seal operation but before cipher text |
| | replacement. Count includes fields from MKDigest up to |
| | and including the Pad field. |
| MKDigest | 20 byte result of SHA1 digest of the master key. |
| Initialization Vector (IV) | Random initialization vector for Cipher Block Chaining (CBC) mode |
| Sealers CodeDigest (SCD) | Result of SHA1 digest of code for the program that sealed this container |
| Data | Data with a format determined by the OpCode. |
| MAC | HMAC cryptographic primitive = HMAC(NewKey(Key, UsageAppMac, Payload) |
| Pad | Number of Pad bytes is set to make sure that the Plain text |
| | is a multiple of 16 bytes. Each padding byte has a value |
| | equal to the number of padding bytes in the Pad buffer. |

TABLE 7
Final Sealed Structure

| Field Name | SMI Sealing Final |
|---|---|
| OpCode | Indicates contents and format of the data field |
| Format | FmtMKContainer |
| Reserved | 0. This will be used in the future for extended opcode information. |
| Length | Count of bytes after seal operation but before ciphertext |
| | replacement. Count includes fields from MKDigest up to |
| | and including the Pad field. |
| MKDigest | 20 byte result of SHA1 digest of the master key. |
| Initialization Vector (IV) | Random initialization vector for Cipher Block Chaining |
| | (CBC) mode |
| SealersCodeDigest (SCD) | Result of SHA1 digest of code for the program that |
| | sealed this container |
| Data | Data with a format determined by the OpCode. |
| MAC | HMAC cryptographic primitive = HMAC(NewKey(Key, |
| | UsageAppMac, Payload) |
| Pad | Number of Pad bytes is set to make sure that the Plaintext |
| | is a multiple of 16 bytes. Each padding byte has a value |
| | equal to the number of padding bytes in the Pad buffer. |

TABLE 8
SignedContainer Structure

| Offset | Size | Field Name | Description |
|---|---|---|---|
| 0x00 | 1 bytes | OpCode | Indicates contents and format of the data field |
| 0x01 | 1 bytes | Format | FmtMk Container |
| 0x02 | 4 bytes | Reserved | 0. This will be used in the future for extended opcode information. |
| 0x06 | 2 bytes | Length | Count of remaining bytes with MSB first. For a sealed container this includes the |
| | | | length of the Mac and Padding bytes, for an unsealed container it does not include |
| | | | either the Mac or Padding byte lengths (i.e., it specifies the total byte length of items |
| | | | MKDigest through Data). |
| 0x08 | 20 bytes | PublicKeyDigest | SHA1 digest of the public key that should be used to verify the signature block. |
| | | | Random initialization vector for Cipher Block Chaining (CBC) mode. IV is |
| | | | passed in by the OSD Security module. |
| 0x28 | 0-64000 bytes | Data | Data with a format determined by the OpCode. |
| Varies | 128 bytes | SigRSABlock | When unsealed, this field begins with padding bytes set to zero and ends with a |
| | | | 20-byte Digest value. The Digest is the SHA1 digest of Opcode ∥ Format ∥ |
| | | | Unsealed-Length ∥ PublicKeyDigest ∥ Data. The sealed version of this field is |
| | | | RSA encrypted with a private key |

TABLE 9
Final Sealed Structure

| Field Name | Description |
|---|---|
| OpCode | Indicates contents and format of the data field |
| Format | FmtSignedContainer |
| Reserved | 0. This will be used in the future for extended opcode information. |
| Length | Count of remaining bytes with MSB first. The unsealed length includes the |
| | PublicKeyDigest and the Data but not the SigRSABlock. The sealed length |
| | include the 128 bytes of the SigRSABlock. |
| PublicKeyDigest | SHA1 digest of the public key that should be used to verify the signature block. |
| Data | Data with a format determined by the OpCode. |
| SigRSABlock | When unsealed, this field begins with padding bytes set to zero and ends with a |
| | 20-byte Digest value. The Digest is the SHA1 digest of Opcode ∥ Format ∥ |
| | Unsealed-Length ∥ PublicKeyDigest ∥ Data. The sealed version of this field is |
| | RSA encrypted with a private key |

TABLE 10

| | | | |
|---|---|---|---|
| Offset | Size | Field Name | Description |

PubKcontiner structure with embedded MKContainer

| | | | |
|---|---|---|---|
| 0x00 | 1 bytes | OpCode | Indicates contents and format of the data field |
| 0x01 | 1 bytes | Format | FmtPubKContainer |
| 0x02 | 4 bytes | Reserved | 0. This will be used in the future for |
| | | | extended opcode information. |
| 0x06 | 2 bytes | Length | Count of remaining bytes with MSB first. For a |
| | | | sealed container this includes the length of Mac |
| | | | and Padding bytes, for an unsealed container it |
| | | | does not include either the Mac or Padding byte |
| | | | lengths (i.e., it specifies the total byte length of |
| | | | items at offsets ###todo: get offsets). |
| 0x08 | 20 | PublicKeyDigest | Result of SHA1 digest of the public key |
| | bytes | | (generally the Server Communication Key). |
| 0x1c | 128 | PubKRSABlock | When unsealed this field begins with padding |
| | bytes | | bytes set to zero and ends with Opcode ∥ |
| | | | Format ∥ KID ∥ MK. These fields have fixed |
| | | | lengths. When sealed, this is an RSA encrypted |
| | | | value. The Opcode is item 1 above, not the |
| | | | Opcode for the MKContainer. If the first part is |
| | | | reused, the Opcode in the PubKRSABlock may |
| | | | not match item 1 but instead may be one of a |
| | | | small number of acceptable alternative values |
| | | | that indicate the reuse of the block. |

Embeded MKContainer starts at offset 0x98

| | | | |
|---|---|---|---|
| +0x00 | 1 bytes | OpCode | Indicates contents and format of the data field |
| +0x01 | 1 bytes | Format | FmtMKContainer |
| +0x02 | 4 bytes | Reserved | 0. This will be used in the future for |
| | | | extended opcode information. |
| +0x06 | 2 bytes | Length | Count of remaining bytes with MSB first. |
| | | | The unseal length includes items at offsets |
| | | | +0x04 to +0x3C, whereas the sealed length |
| | | | includes items at offsets. |
| +0x08 | 20 bytes | MKDigest | 20 byte result of SHA1 digest of the Master |
| | | | Key stored in the 1st part PubKRSABlock. |
| +0x1c | 16 bytes | Initialization | Random initialization vector for Cipher Block |
| | | Vector (IV) | Chaining (CBC) mode. IV is passed in by the |
| | | | OSD Security module. |
| +0x2c | 20 bytes | SealersCode | Result of SHA1 digest of code for the |
| | | Digest (SCD) | program that sealed this container. The SCD |
| | | | is set to zero if the container was sealed by |
| | | | the Device Authority server. The SCD is |
| | | | passed in by the OSD Security module. |
| +0x40 | 0-64000 | Data | Data with a format determined by the OpCode. |
| | bytes | | |
| Varies | 20 bytes | MAC | HMAC cryptographic primitive = HMAC |
| | | | (NewKey(Key, UsageMKMac), Payload) |
| Varies | 1-16 | | Number of Pad bytes is set to make sure that |
| | bytes | | the Plaintext is a multiple of 16 bytes. Each |
| | | | padding byte has a value equal to the number |
| | | | of padding bytes in the Pad buffer. |

TABLE 11

| | |
|---|---|
| Field Name | Description |

Final Sealed PubKContainer Structure

| | |
|---|---|
| OpCode | Indicates contents and format of the data field |
| Format | FmtPubKContainer |
| Reserved | 0. This will be used in the future for extended opcode information. |
| Length | Count of remaining bytes with MSB first. For a |
| | sealed container this includes the length of the Mac |
| | and Padding bytes, for an unsealed container it does |
| | not include either the Mac or Padding byte lengths |
| | (i.e., it specifies the total byte length of items at |
| | offsets ###todo: get offsets). |
| PublicKeyDigest | Result of SHA1 digest of the public key (generally the Server |
| | Communication Key). |
| PubKRSABlock | When unsealed this field begins with padding bytes set to |
| | zero and ends with Opcode ∥ Format ∥ KID ∥ MK. These |
| | fields have fixed lengths. When sealed, this is an RSA |
| | encrypted value. The Opcode is item 1 above, not the |
| | Opcode for the MKContainer. If the first part is reused, the |
| | Opcode in the PubKRSABlock may not match item 1 but |
| | instead may be one of a small number of acceptable |
| | alternative values that indicate the reuse of the block. |

Embedded MKContainer starts at offset 0x98

| | |
|---|---|
| OpCode | Indicates contents and format of the data field |
| Format | FmtMKContainer |
| Reserved | 0. This will be used in the future for |
| | extended opcode information. |
| Length | Count of remaining bytes with MSB first. The unseal |
| | length includes items at offsets +0x04 to +0x3C, |
| | whereas the sealed length includes items at offsets. |
| MKDigest | 20 byte result of SHA1 digest of the Master |
| | Key stored in the 1st part PubKRSABlock. |
| InitializationVector | Random initialization vector for Cipher Block Chaining (CBC) |
| (IV) | mode. IV is passed in by the OSD Security module. |
| SealersCodeDigest | Result of SHA1 digest of code for the program that |
| (SCD) | sealed this container. The SCD is set to zero if the |
| | container was sealed by the Device Authority server. |
| | The SCD is passed in by the OSD Security module. |
| Data | Data with a format determined by the OpCode. |
| MAC | HMAC cryptographic primitive = HMAC |
| | (NewKey(Key, UsageMKMac), Payload) |
| Pad | Number of Pad bytes is set to make sure that the Plaintext is |
| | a multiple of 16 bytes. Each padding byte has a value equal |
| | to the number of padding bytes in the Pad buffer. |

TABLE 12

| | |
|---|---|
| Field Name | Description |

Final Sealed PubKContainer Structure

| | |
|---|---|
| OpCode | Indicates contents and format of the data field |
| Format | FmtPubKContainer |
| Reserved | 0. This will be used in the future for extended information.opcode |
| Length | Count of remaining bytes with MSB first. For a sealed |
| | container this includes the length of the Mac and Padding |
| | bytes, for an unsealed container it does not include either |
| | the Mac or Padding byte lengths (i.e., it specifies the total |
| | byte length of items at offsets ###todo: get offsets). |
| PublicKeyDigest | Result of SHA1 digest of the public key (generally the |
| | Server Communication Key). |
| PubKRSABlock | When unsealed this field begins with padding bytes set to |
| | zero and ends with Opcode ∥ Format ∥ KID ∥ MK. These |
| | fields have fixed lengths. When sealed, this is an RSA |
| | encrypted value. The Opcode is item 1 above, not the |
| | Opcode for the MKContainer. If the first part is reused, the |
| | Opcode in the PubKRSABlock may not match item 1 but |
| | instead may be one of a small number of acceptable |
| | alternative values that indicate the reuse of the block. |

Embeded MkContainer starts at offset 0x98

| | |
|---|---|
| OpCode | Indicates contents and format of the data field |
| Format | FmtMKContainer |
| Reserved | 0. This will be used in the future for extended opcode information. |
| Length | Count of remaining bytes with MSB first. The unseal |
| | length includes items at offsets +0x04 to +0x3C, whereas |
| | the sealed length includes items at offsets. |
| MKDigest | 20 byte result of SHA1 digest of the Master |
| | Key stored in the 1st part PubKRSABlock. |
| Initialization Vector | Random initialization vector for Cipher Block Chaining |
| (IV) | (CBC) mode. IV is passed in by the OSD Security module. |
| SealersCode | Result of SHA1 digest of code for the program that sealed |
| Digest (SCD) | this container. The SCD is set to zero if the container was |
| | sealed by the Device Authority server. The SCD is passed |
| | by the OSD Security module. |
| Data | Data with a format determined by the OpCode. |
| MAC | HMAC cryptographic primitive = HMAC (NewKey(Key, |
| | UsageMKMac), Payload) |
| Pad | Number of Pad bytes is set to make sure that the Plaintext |
| | is a multiple of 16 bytes. Each padding byte has a value |
| | equal to the number of padding bytes in the Pad buffer. |

TABLE 13
Final Sealed Structure

| Field Name | SMI Sealing Final |
|---|---|
| OpCode | Indicates contents and format of the data field |
| Format | FmtMKContainer |
| Reserved | 0. This will be used in the future for extended opcode information. |
| Length | Count of bytes after seal operation but before ciphertext |
| | replacement. Count includes fields from MKDigest upto |
| | and including the Pad field. |
| MKDigest | 20 byte result of SHA1 digest of the master key. |
| Initialization Vector (IV) | Random initialization vector for Cipher Block Chaining (CBC) mode |
| SealersCodeDigest (SCD) | Result of SHA1 digest of code for the program that sealed this container |
| Data | Data with a format determined by the OpCode. |
| MAC | HMAC cryptographic primitive = HMAC(NewKey(Key, UsageAppMac, Payload) |
| Pad | Number of Pad bytes is set to make sure that the Plaintext is a |
| | multiple of 16 bytes. Each padding byte has a value equal to the |
| | number of padding bytes in the Pad buffer. |

TABLE 14
12.5.2 Authorization Buffer

| 32 bits | 32 bits | 160 bits | 64 bits | 8 bits |
|---|---|---|---|---|
| StartAddress of OSD | Block End Address | Block Code Digest | PrivilegeVector | Frequency of |
| Service Invocation | of OSD Service | of OSD Service | | Integrity |
| | Invocation | invocation Block | | Checking |

TABLE 15
Registered Application Table

| 32 bits | 32 bits | 160 bits | 64 bits |
|---|---|---|---|
| Process ID | StartAddress of | Code Digest of | Code Digest of |
| | OSD Service | OSD Service | OSD Service |
| | invocation Block | invocation Block | invocation Block |

What is claim is:

1. A method of sending a secure message between a first application program and a second application program by restricting the use of a cryptographic key to the first application program and the second application program, said first application program and the second application program running on a device, comprising:
providing a first key known to a cryptographic processing module;
providing an application container data structure that contains a cryptographically sealed form of the data for the first application program and second application program to access;
performing a cryptographic gatekeeping function that computes a cryptographic digest of a portion of an in-memory image of at least one of the first application program and second application program;
performing an integrity-check by the cryptographic processing module by examining the application container data structure, the cryptographic digest, and the first key to determine if at least one of the first application program and second application program is allowed to unseal the cryptographically sealed form of the data; and
authenticating, by the first application program, the secure message sent by the second application using the application container data structure.

2. The method of claim 1 further comprising performing a privacy operation by the cryptographic processing module that encrypts or decrypts the cryptographically sealed form of the data in the application container data structure using a key derived from at least the first key and cryptographic digest, and when the cryptographically sealed form of the data is to be encrypted, the crytographic processing module adds to the application container data structure the cryptographic digest before the encryption is performed.

3. The method of claim 1 further comprising providing an authorization buffer that specifies the result of the integrity-check, and wherein the cryptographic gatekeeping function confirms that the at least one of the first application program and second application program is allowed to unseal the cryptographically sealed form of the data.

4. The method of claim 1 wherein the integrity-check includes:
deriving a cryptographic variable from the cryptographic digest and the first key; and
using the cryptographic variable to check a message authentication code that is stored in the application container data structure.

5. The method of claim 1 wherein the integrity-check includes:
decrypting data derived from the application container data structure using a key derived from the first key to create a resulting value and comparing the resulting value to data derived from the cryptographic digest; and
allowing access to the cryptographically sealed form of the data if the resulting value is the same as the data derived from the cryptographic digest.

6. The method of claim 2 wherein the privacy operation includes:
deriving a cryptographic variable from the cryptographic digest and the first key, wherein the cryptographic variable is used to decrypt or encrypt a portion of the application container data structure.

7. The method of claim 1 wherein the first key is stored in a secure database indexed by a key ID.

8. The method of claim 1 wherein the device is one of an encryption/decryption hardware device and a limited access server.

9. A system for sending a secure message between a first application program and a second application program by restricting the use of a cryptographic key to the first application program and the second application program running on a device of said system, comprising:
a memory containing instruction sequences, a first key that is known to a cryptographic processing module, and an application container data structure that contains a cryptographically sealed form of the data for the first application program and second application program to access; and,
a processor, coupled to the memory, said processor to execute the cryptographic processing module, said instruction sequences to cause the processor to:
compute a cryptographic digest of a portion of an in-memory image of at least one of the first application program and second application program;
perform an integrity-check by the cryptographic processing module by examining the application container data structure, the cryptographic digest, and the first key to determine if at least one of the first application program and second application program is allowed to unseal the cryptographically sealed form of the data; and
authenticate, by the first application program, the secure message sent by the second application using the application container data structure.

10. The system of claim 9 wherein said instruction sequences further cause the processor to perform a privacy operation by the cryptographic processing module that encrypts or decrypts the cryptographically sealed form of the data in the application container data structure using a key derived from at least the first key and cryptographic digest, and when the cryptographically sealed form of the data is to be encrypted, the crytographic processing module adds to the application container data structure the cryptographic digest before the encryption is performed.

11. The system of claim 9 further comprising an authorization buffer that specifies the result of the integrity-check, and wherein the system confirms that the at least one of the first application program and second application program is allowed to unseal the cryptographically sealed form of the data.

12. The system of claim 9 wherein said processor, in performing the integrity-check, further:
derives a cryptographic variable from the cryptographic digest and the first key; and
uses the cryptographic variable to check a message authentication code that is stored in the application container data structure.

13. A system of authenticating a device and an application program that is running on the device, said system comprising:
a hidden storage containing a first key;
a memory for storing instruction sequences; and
a processor, coupled to the hidden storage and the memory, said instruction sequences to cause the processor to:
execute a cryptographic gatekeeper module that runs in a restricted mode and computes a cryptographic digest of a portion of the application program; and
authenticate the device and the application program using the first key and the cryptographic digest.

14. The system of claim 13, wherein the application program is part of an operating system kernel.

15. The system of claim 13, wherein the application program and device are authenticated before the application program is allowed to access sensitive data.

16. The system of claim 13, wherein the first key is a shared key for use in a symmetric key cryptosystem.

17. The system of claim 13, wherein firmware controls the system during a system initialization process that begins in response to a power-on or reset signal.

18. The system of claim 13, wherein:
the hidden storage is in a system management random access memory which is not accessible by any program running in a normal operating mode of the system; and
the restricted operating mode is a system management mode in which access to the system management random access memory is permitted.

19. The system of claim 13, wherein the first key is generated in cooperation with a shared server that computes application keys to be shared with at least one other system.

20. The system of claim 13, wherein the shared server shares said application keys with the at least one other system to authenticate devices and device-bound applications.
